(19) United States
(12) Patent Application Publication
(10) Pub. No.: US 2010/0126108 A1
(43) Pub. Date: May 27, 2010

(54) CONNECTOR SYSTEM FOR CONNECTION OF TUBES RODS AND BEAMS FOR CONSTRUCTION OF TRUSSES

(76) Inventor: Themistoklis Andrikopoulos, Keratea (GR)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/593,902

(22) PCT Filed: Apr. 3, 2008
(86) PCT No.: PCT/GR2008/000021

§ 371 Date: Sep. 29, 2009

(30) Foreign Application Priority Data
Apr. 4, 2007 (GR) 20070100204

(51) Int. Cl. E04B 1/00; E04B 1/19; F16B 21/04

(52) U.S. Cl. 52/741.1; 403/171; 403/364

(57) ABSTRACT

This invention refers to a variety of mechanical joints-nodes used to interconnect between them straight parts tubes, rods, beams to construct trusses. In all cases of truss constructions the main question is how to interconnect the straight parts and the usual up to now practices have limited possibilities for mass production of standardized joints-nodes or straight sections that can secure uniform-fixed mechanical strength at the point of interconnection and flexibility in the architectural design. The present invention has achieved the design of a series-variety of standard components for the assembly of joints-nodes with variable-self adjusting angles with moving arms (3) (4) (5) (6) (7) and a series-variety of standard joints-nodes with fixed angles (8) (9) (10) (11) (12) (13) (14) (15) and with the form of DISC (49) or SPHERE, as well as of a two part mechanical connector consisting of a male (47) and a female (48) part, which can be interconnected with lateral movement and interlock with a small turn and can be fixed at the ends of straight parts (21) (25) and be embedded in the arms of the nodes (3) (4) (5) (6) (7), as well as the devising of a method of screwing and unscrewing straight parts (21) (25) by turning in one or the other direction with opposite threadings at their two ends (22R) (23L) and respectively at the arms (3L) (3R) (4L) (4R) (5L) (5R) (6L) (6R) (7L) (7R) of the nodes. All the above can be produced with standardized industrial methods, providing uniform-fixed mechanical strength at the points of inteconnection, flexibility in the architectural design and significant lowering of costs. This invention can be used in Construction-Architecture and Decorative designs, but also for bridges and dwellings for immediate covering of special needs in disaster areas, greenhouses, scaffolding, sheds, towers, modular assemblies of educational games.etc.

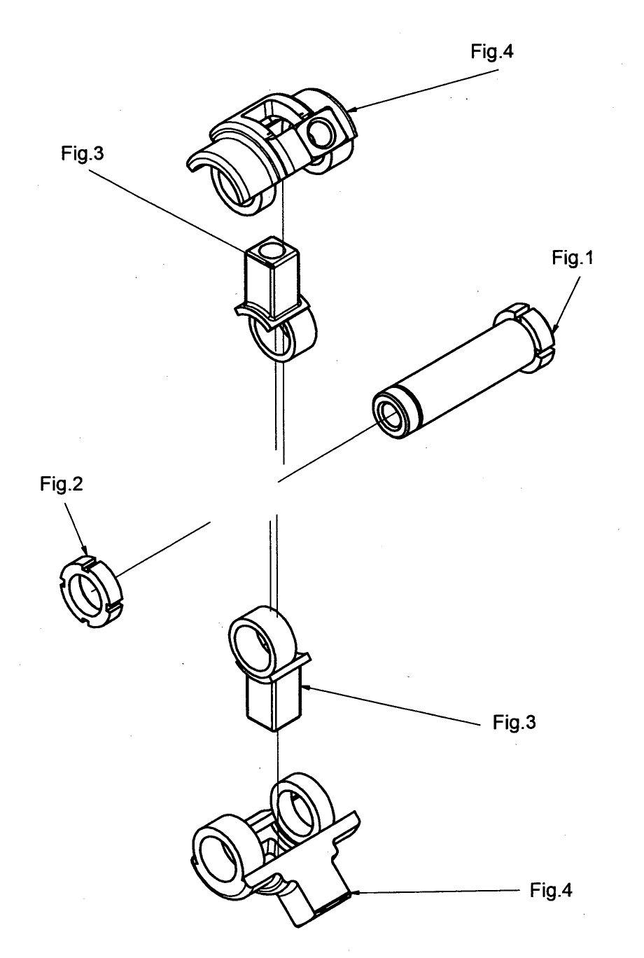

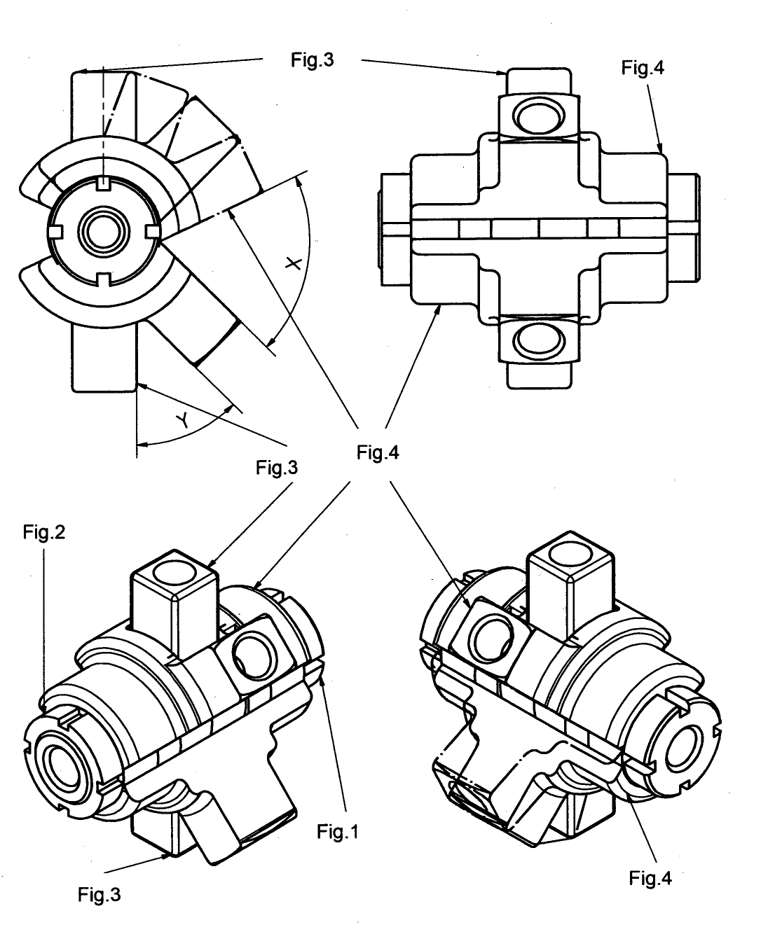

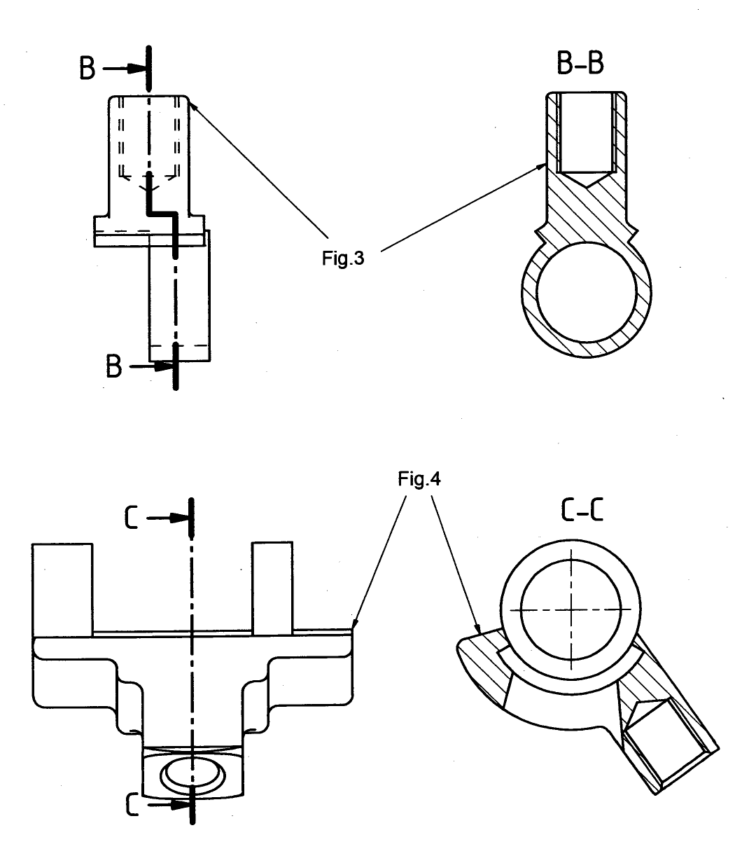

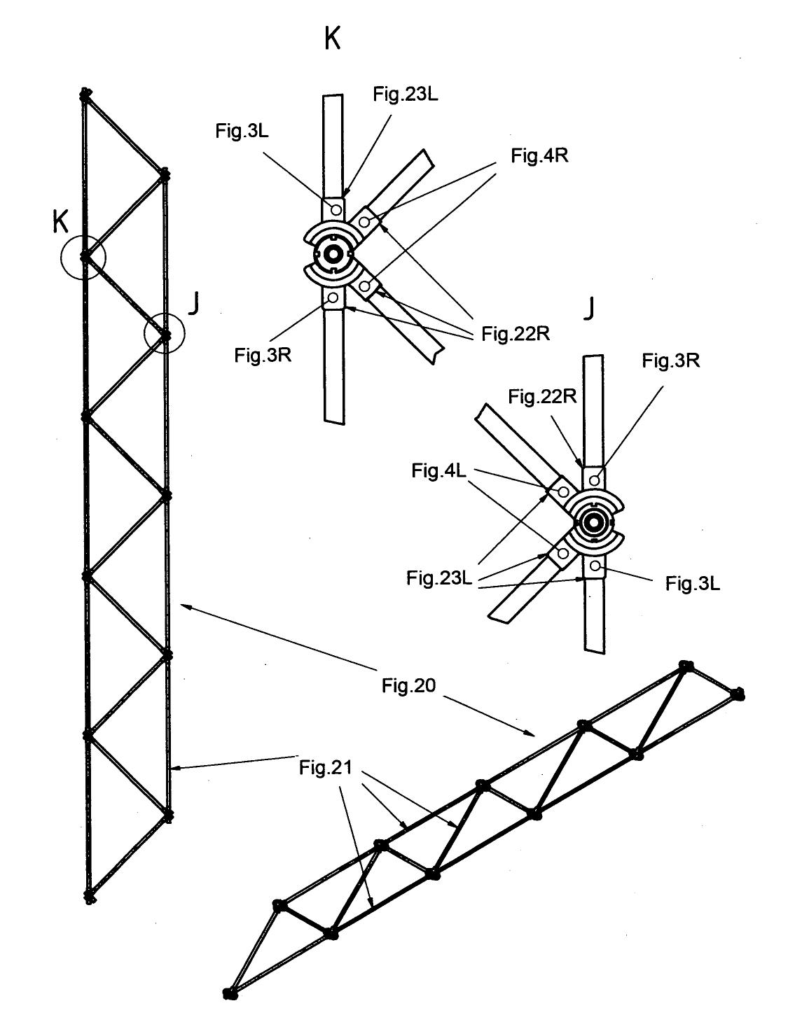

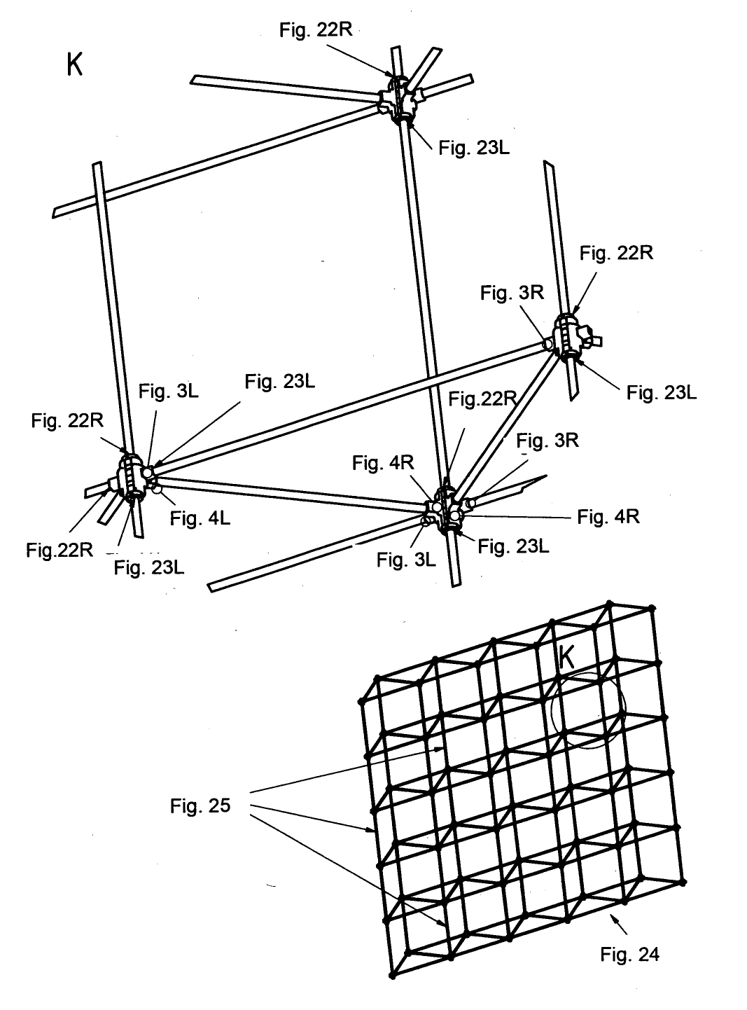

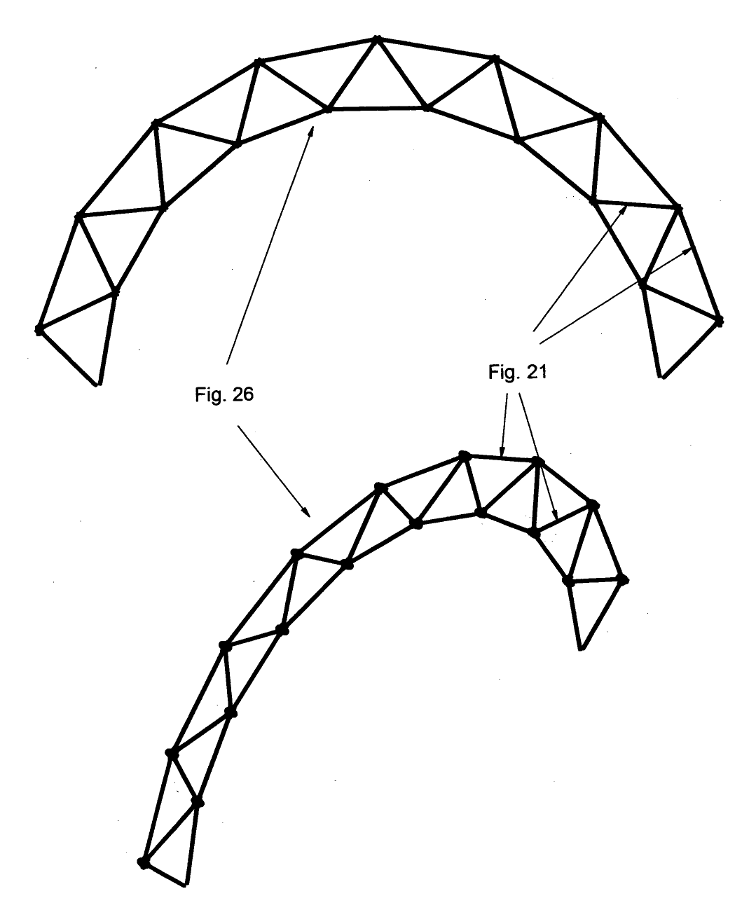

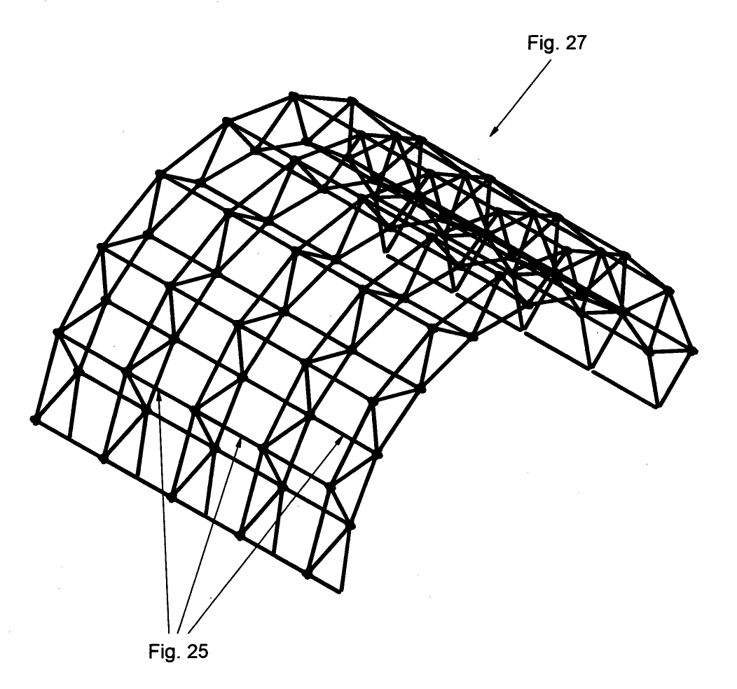

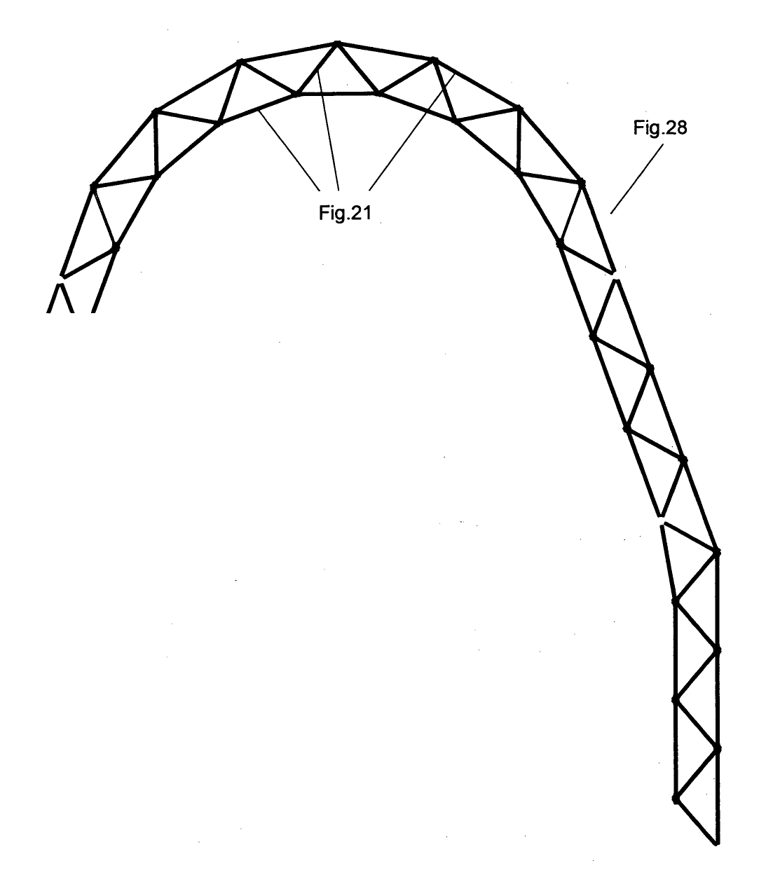

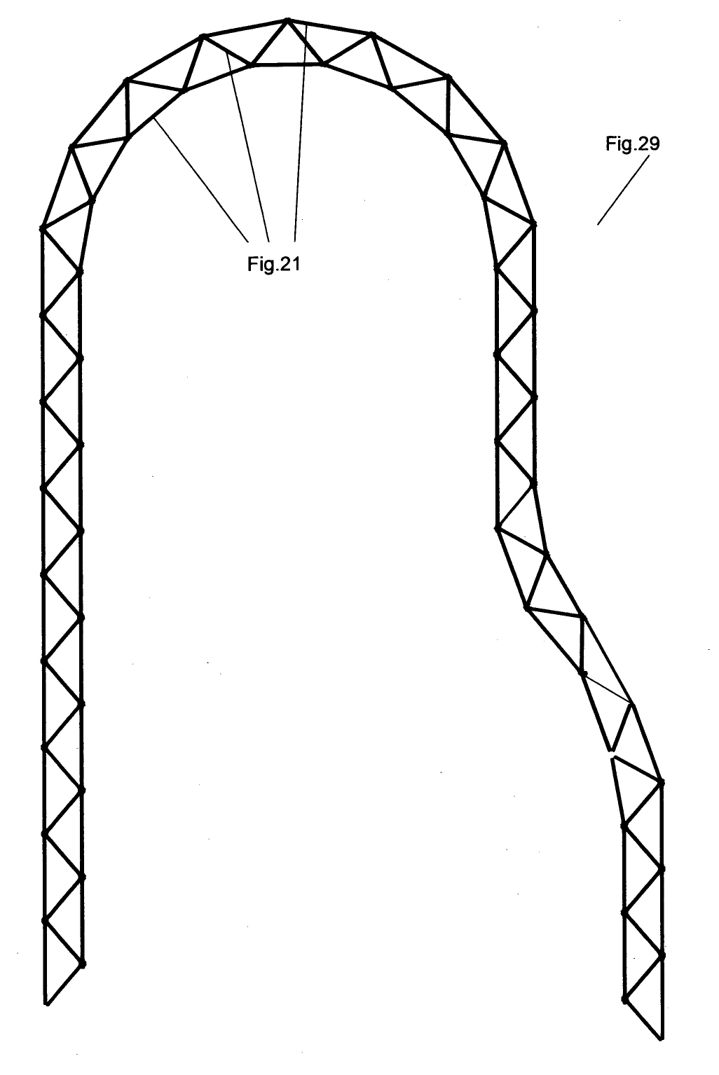

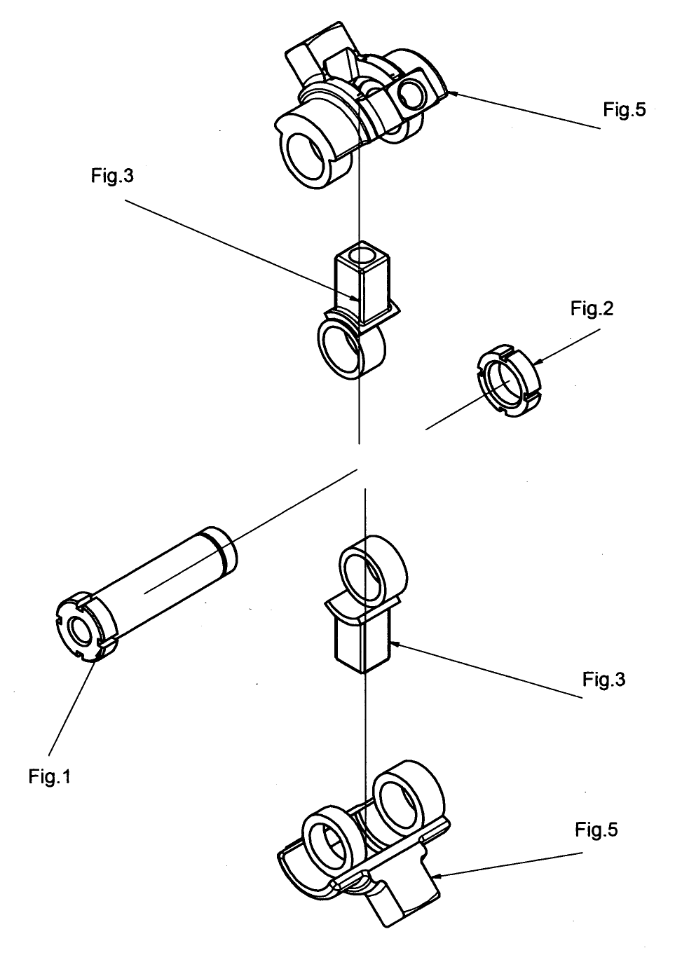

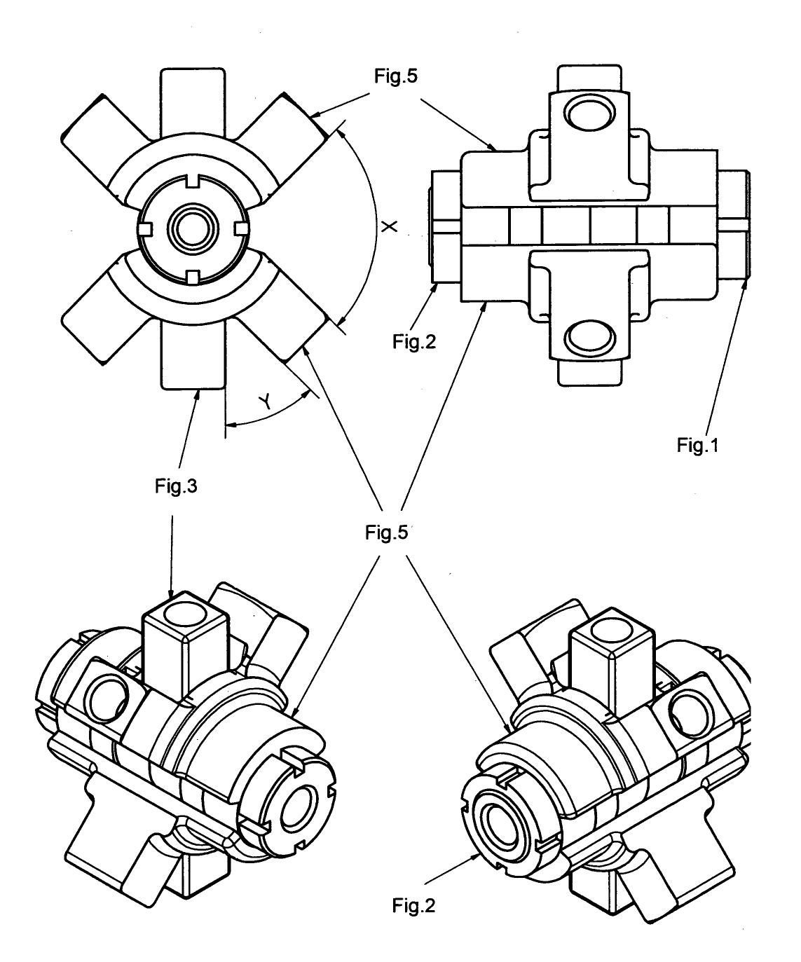

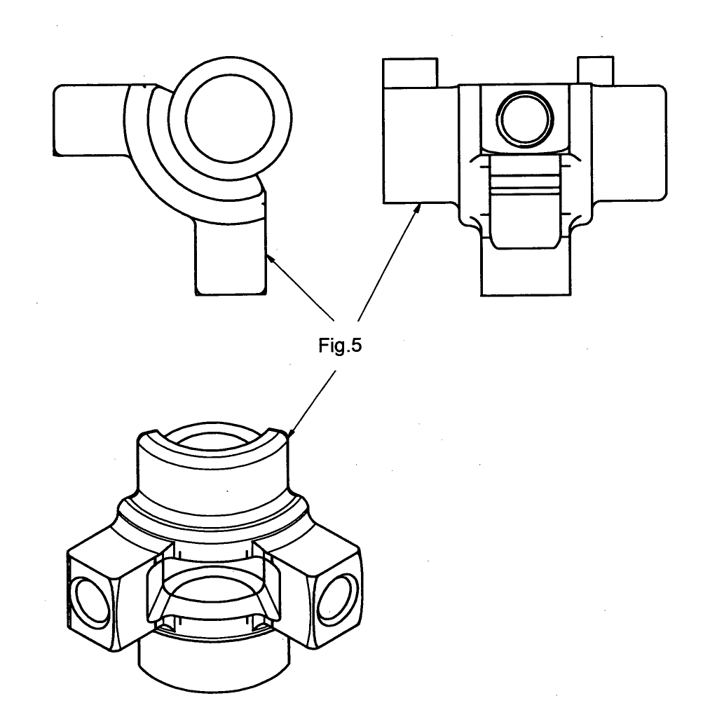

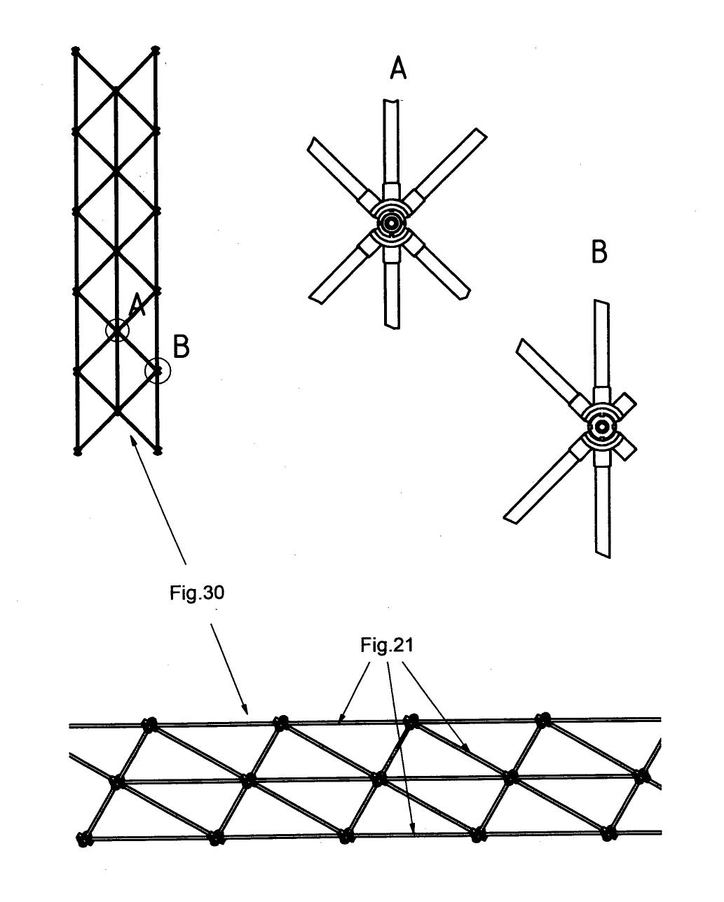

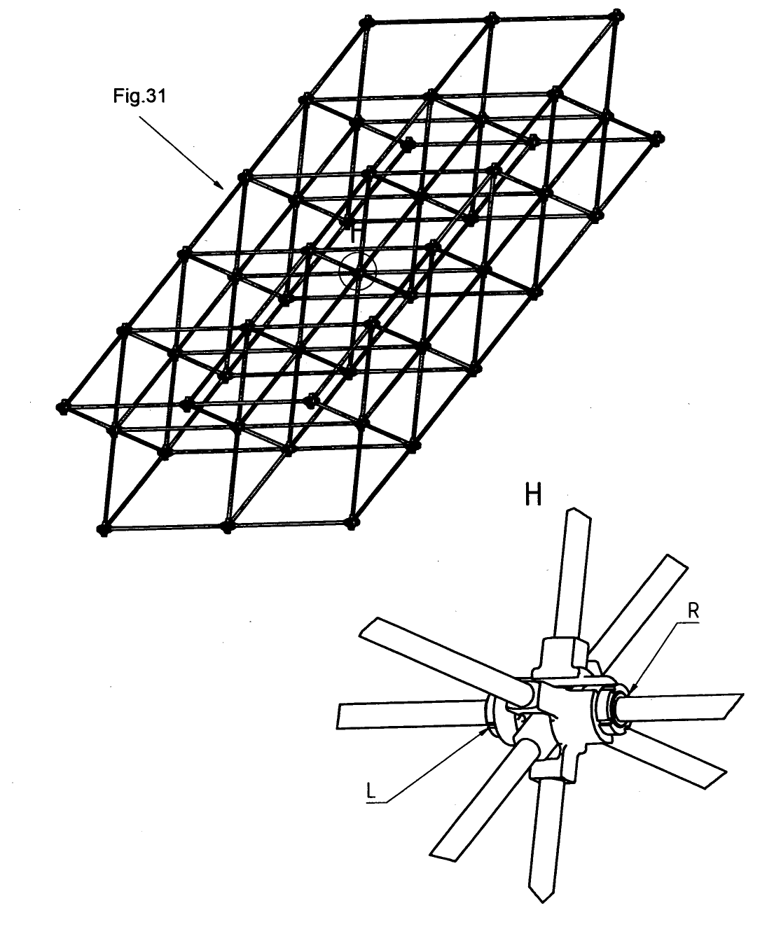

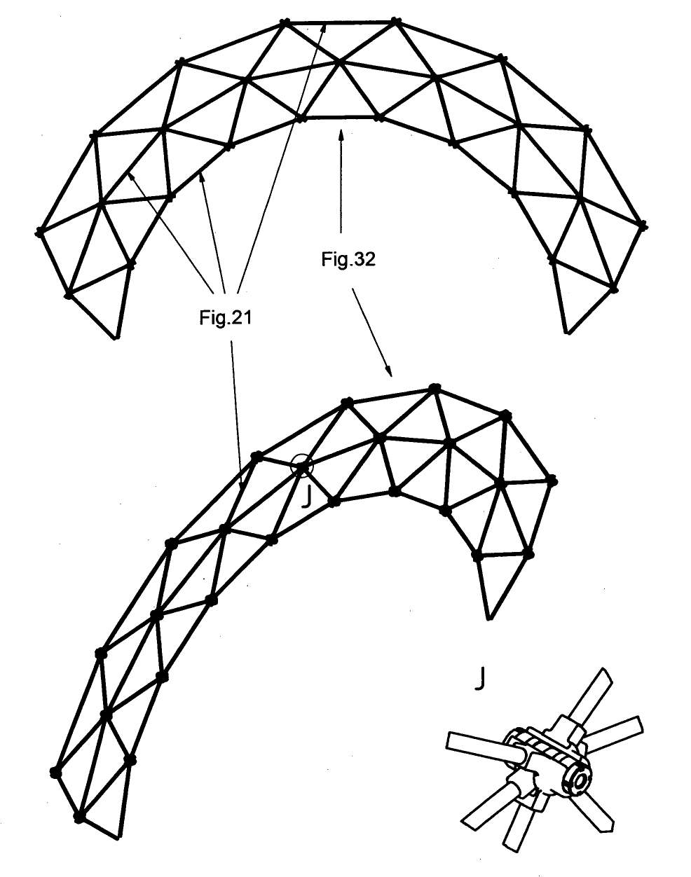

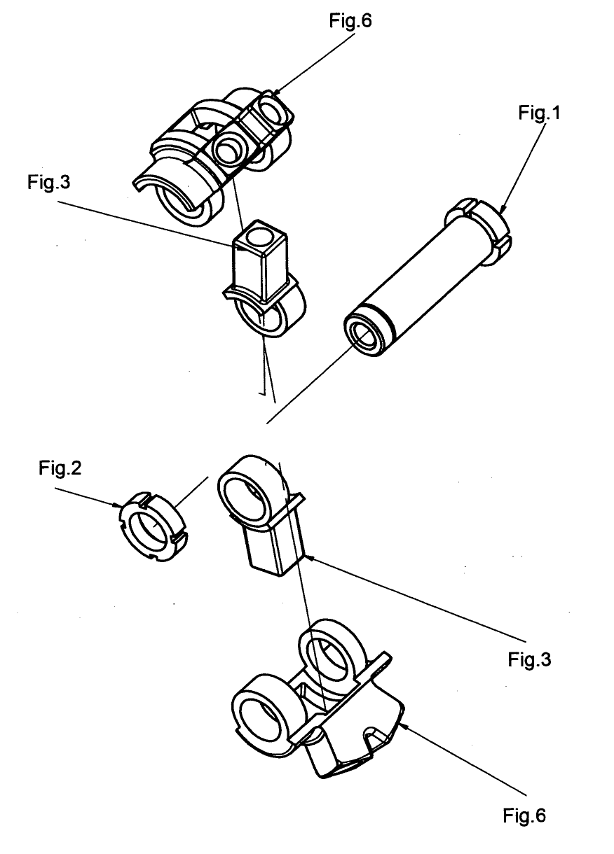

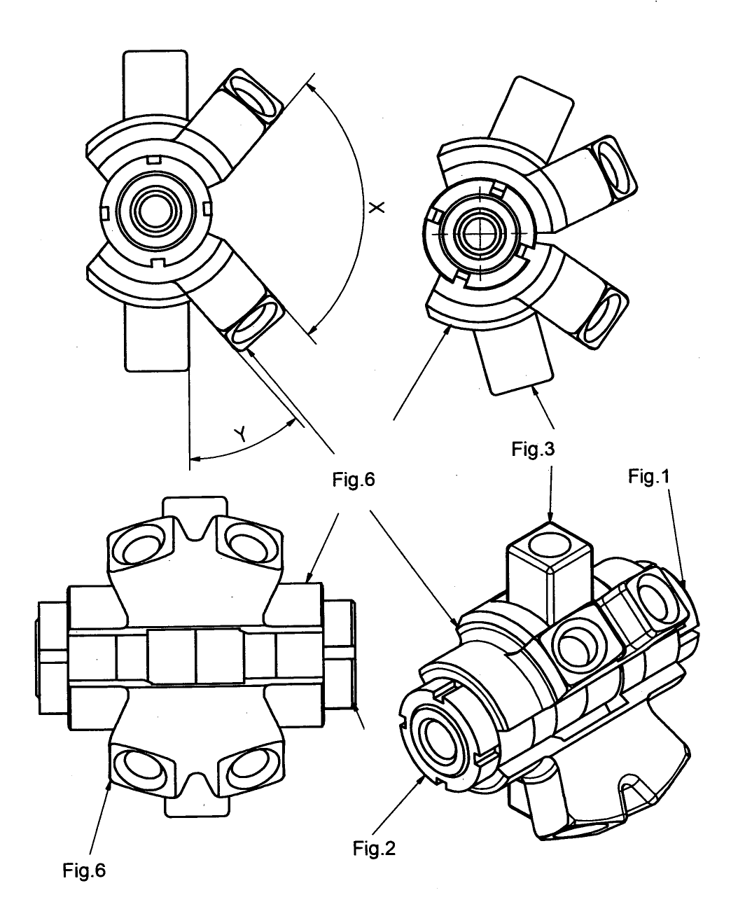

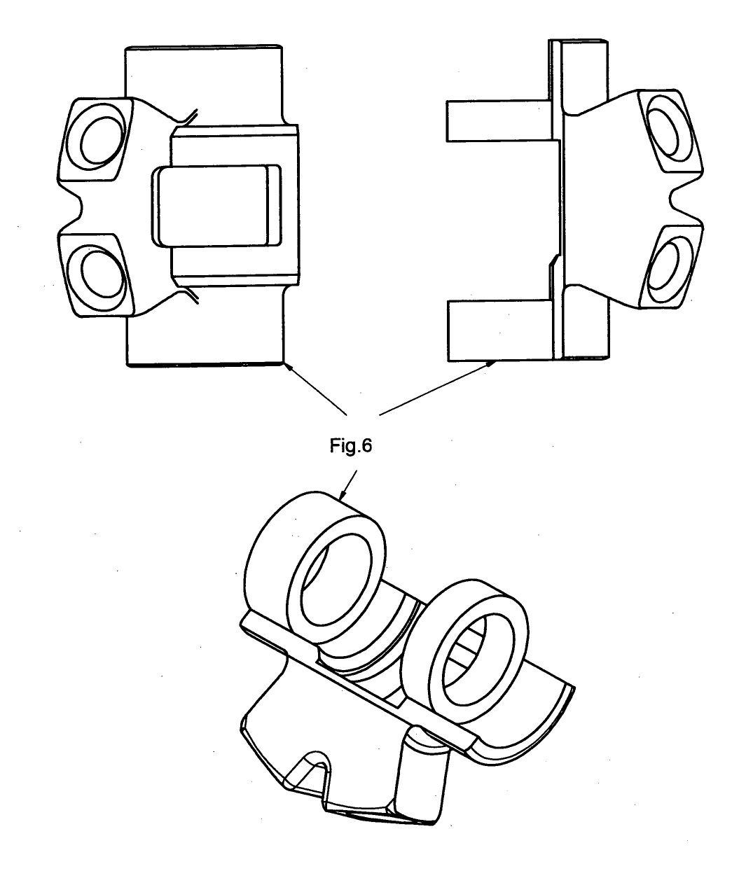

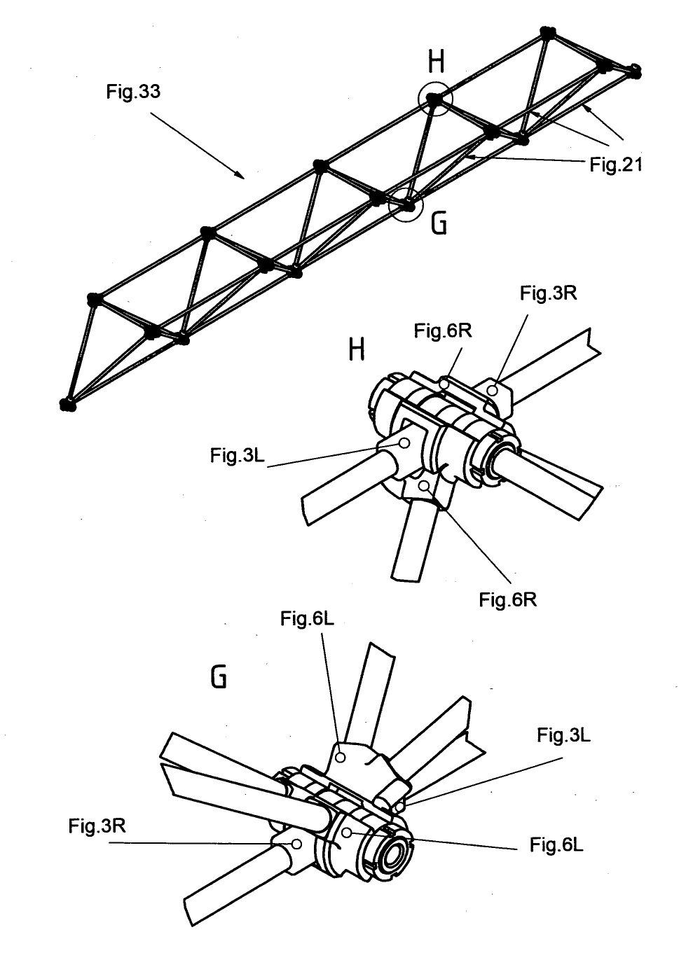

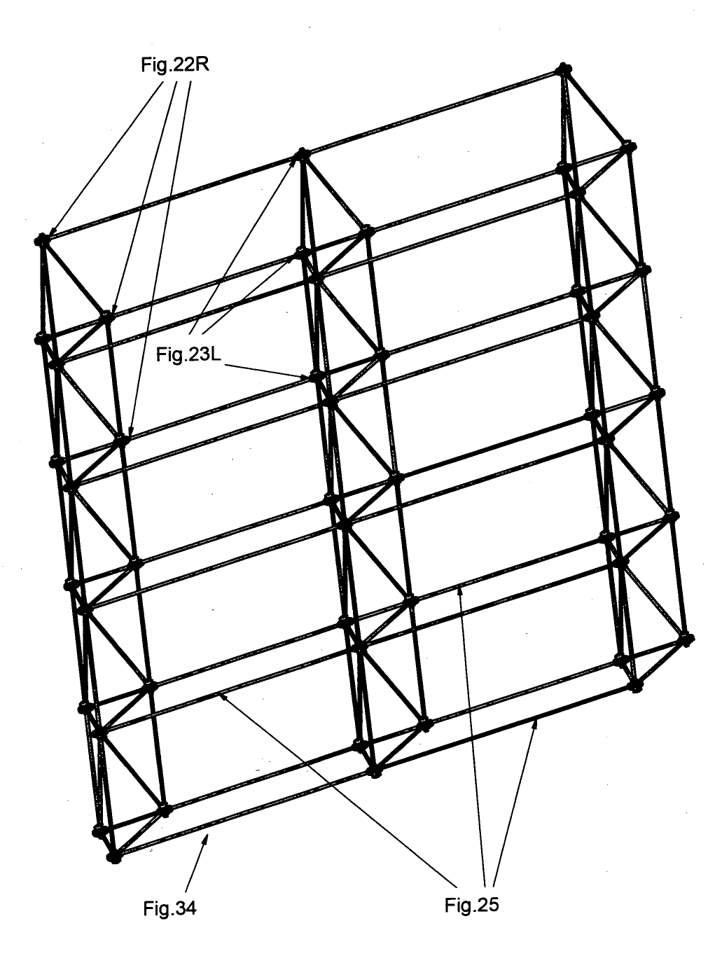

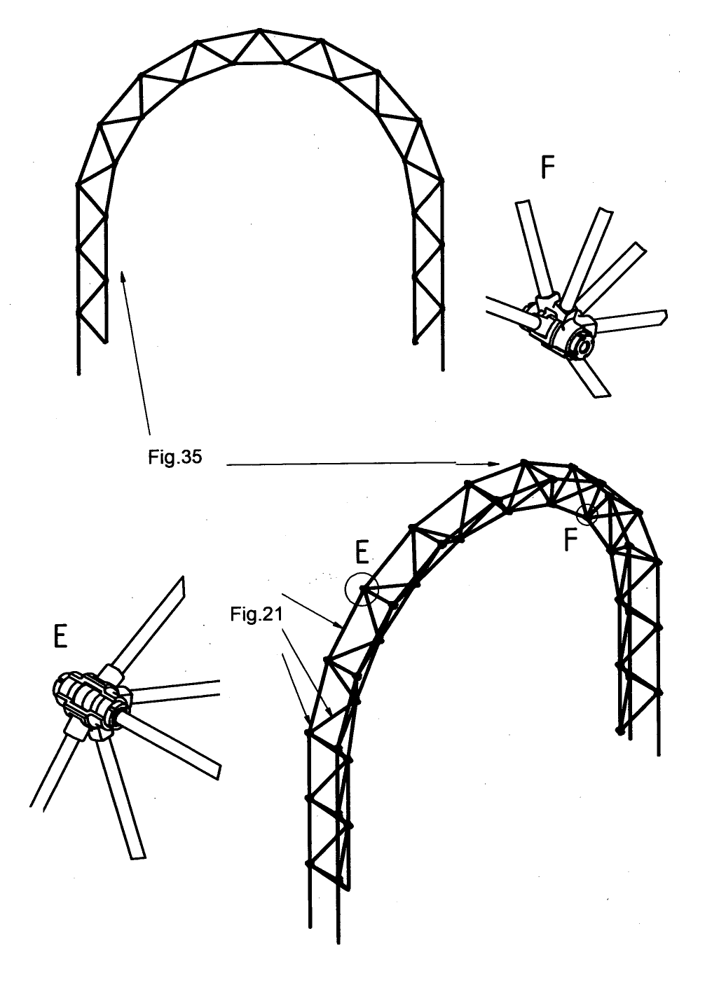

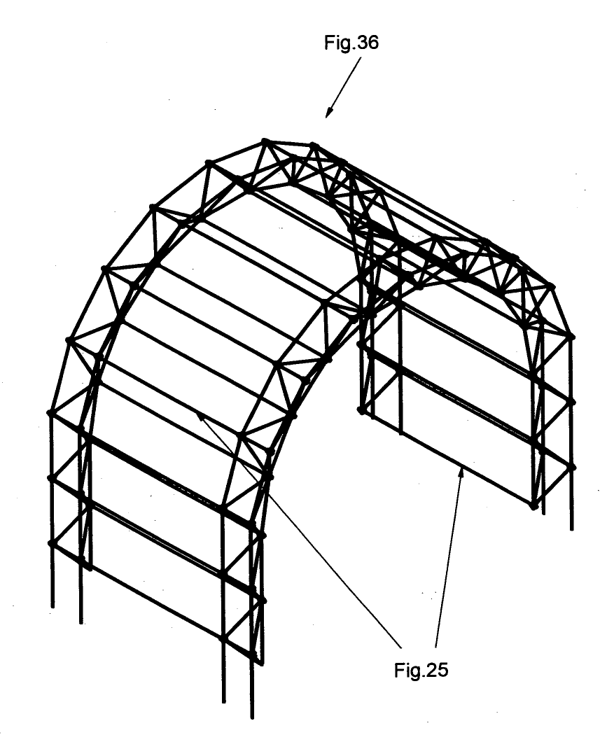

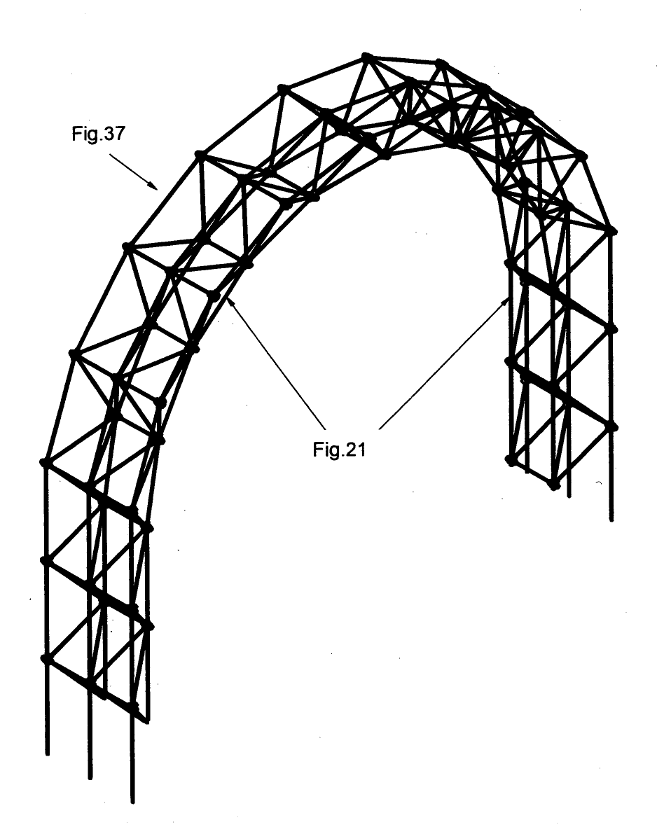

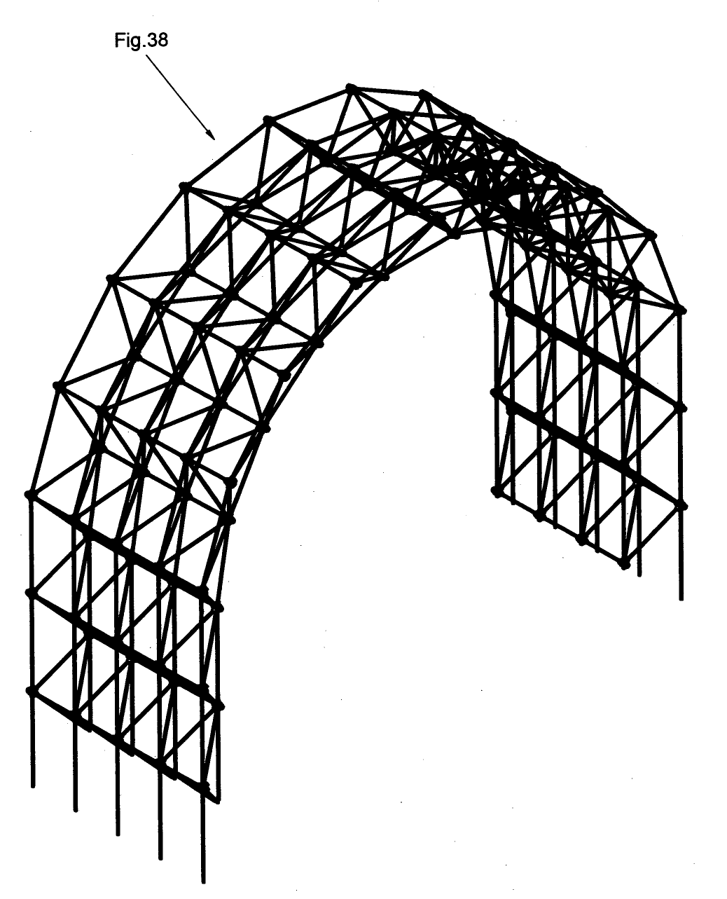

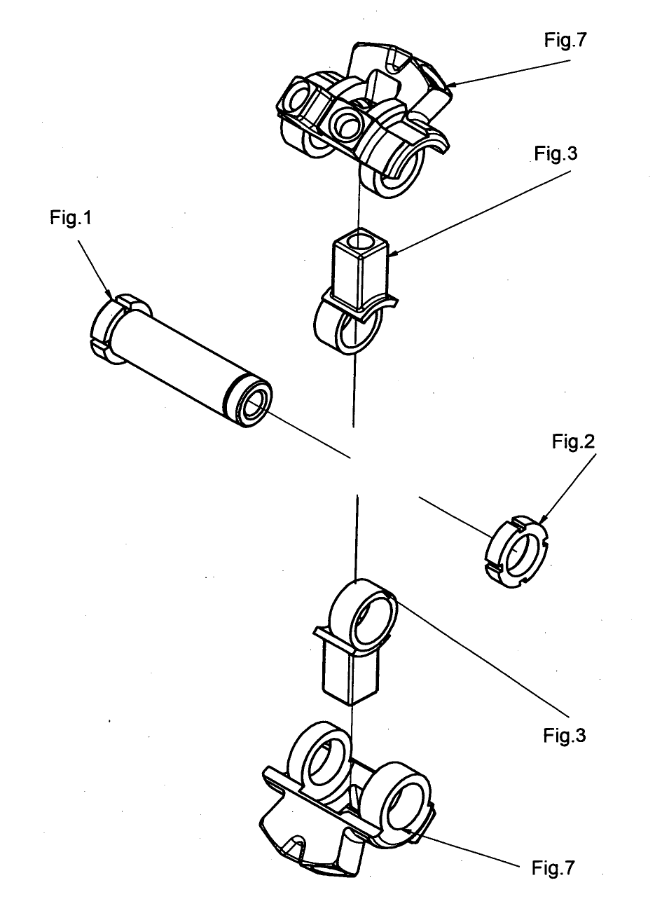

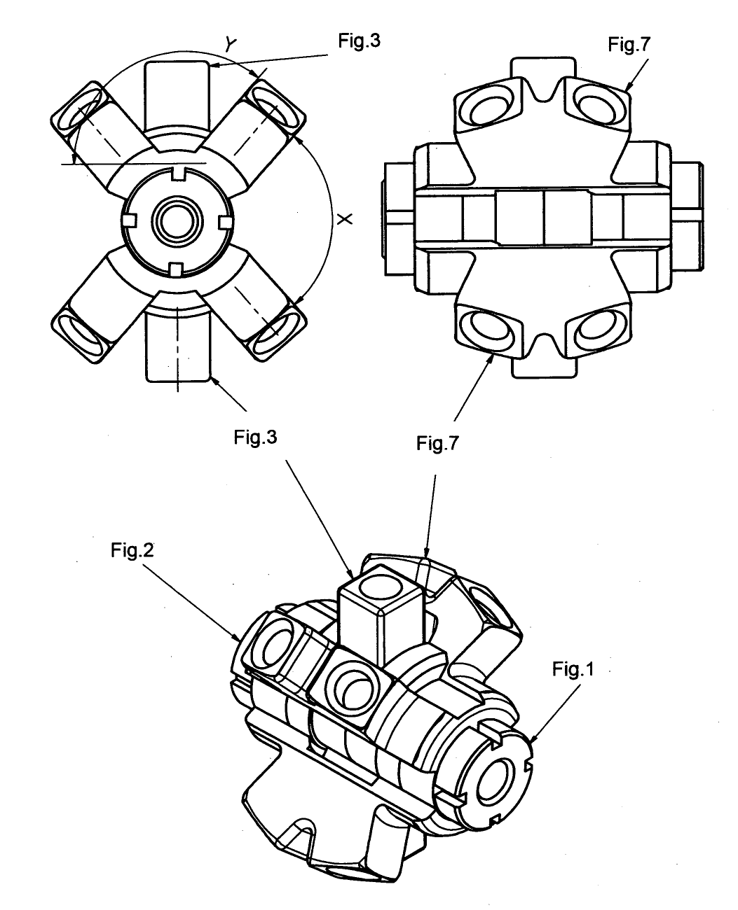

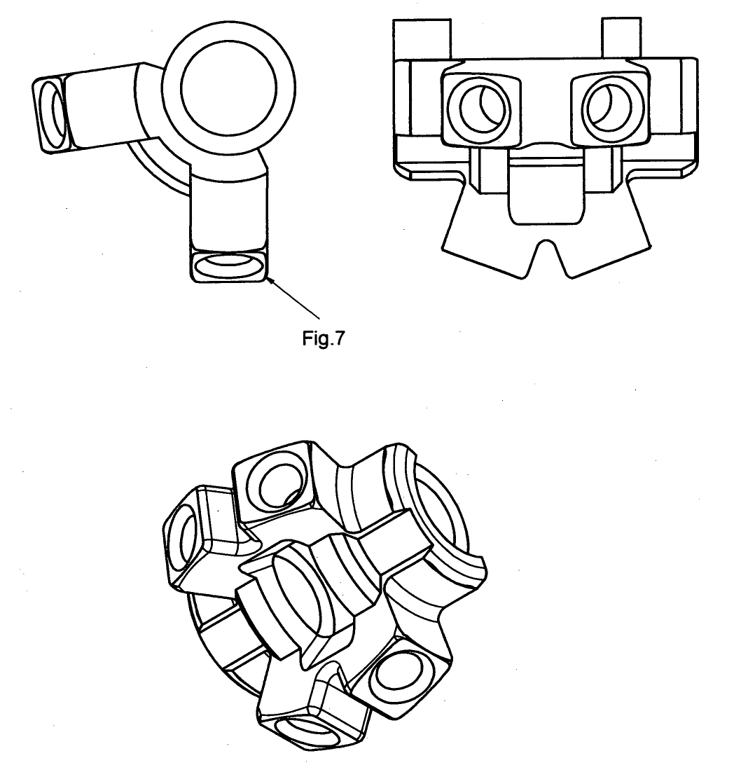

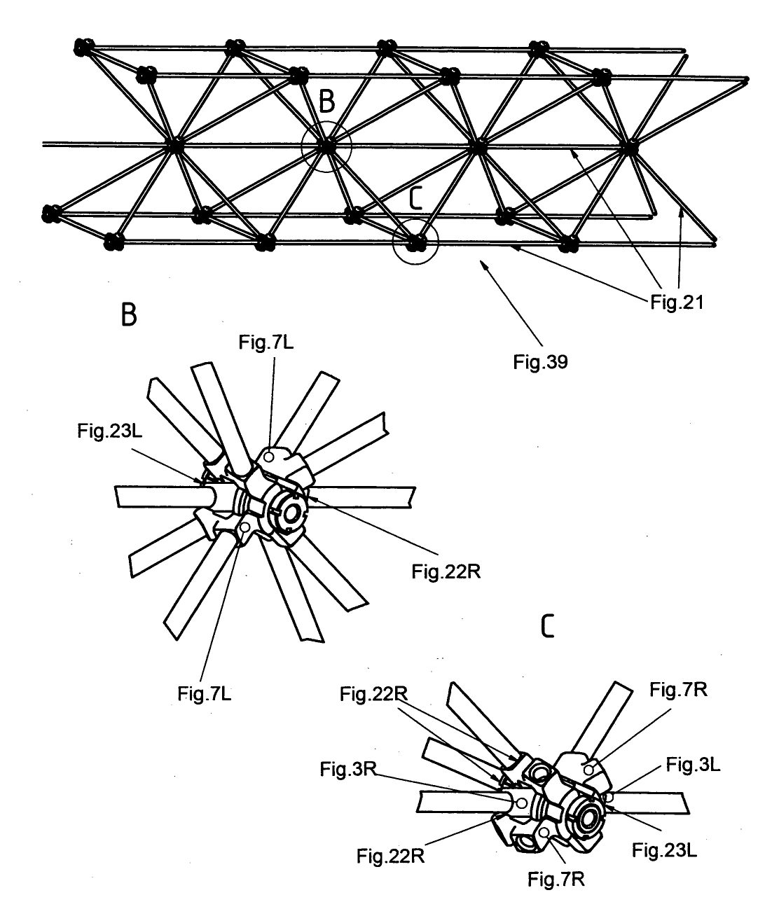

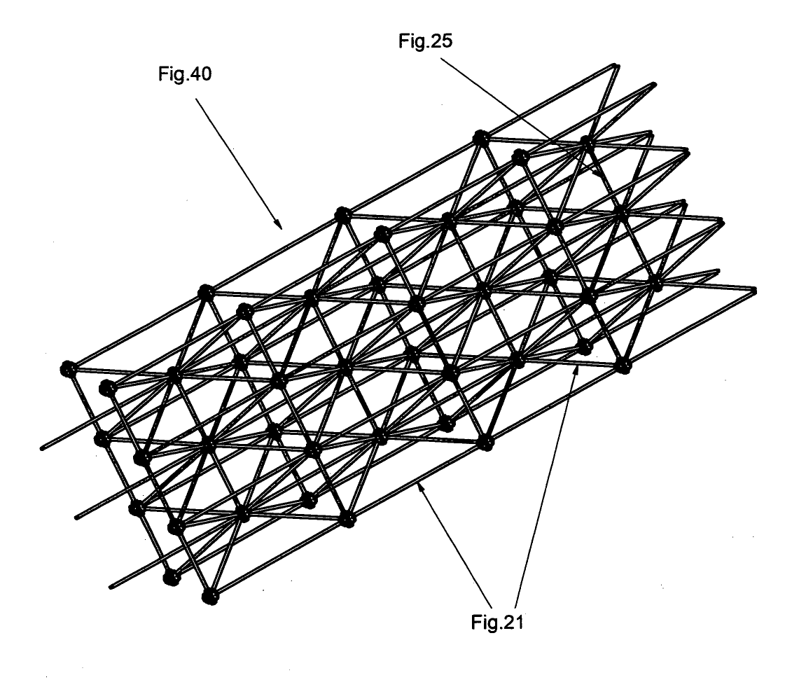

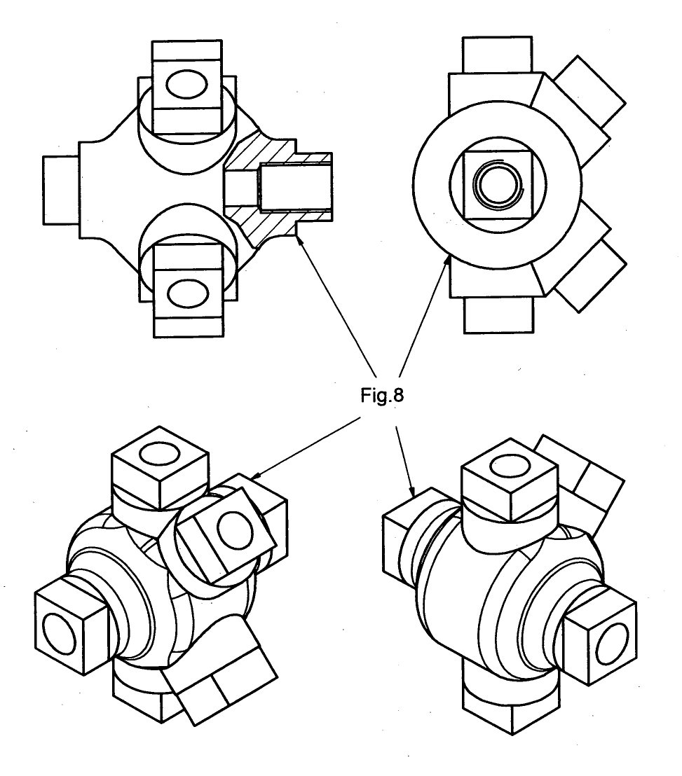

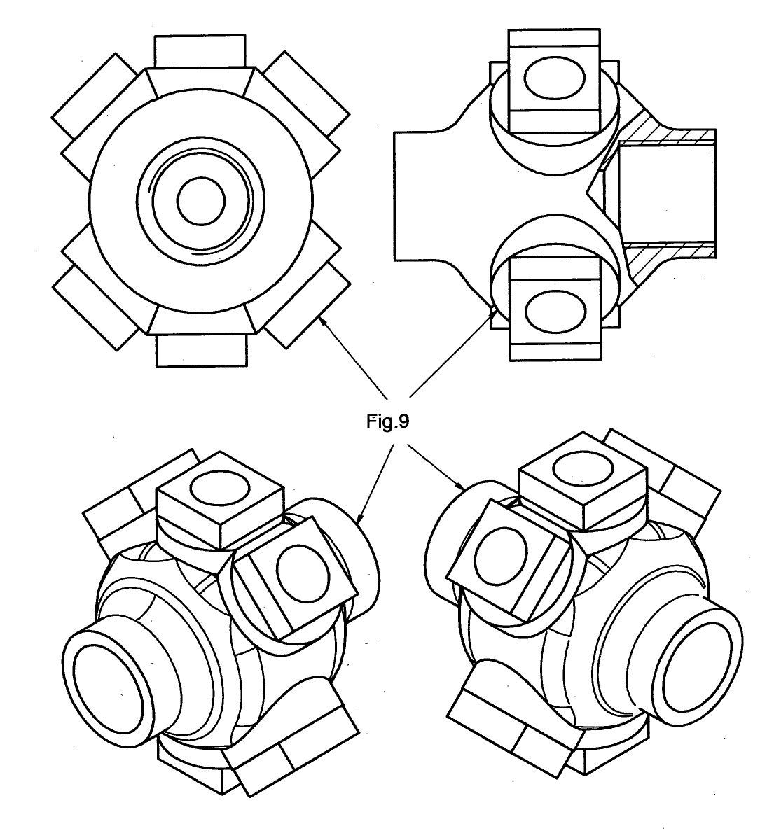

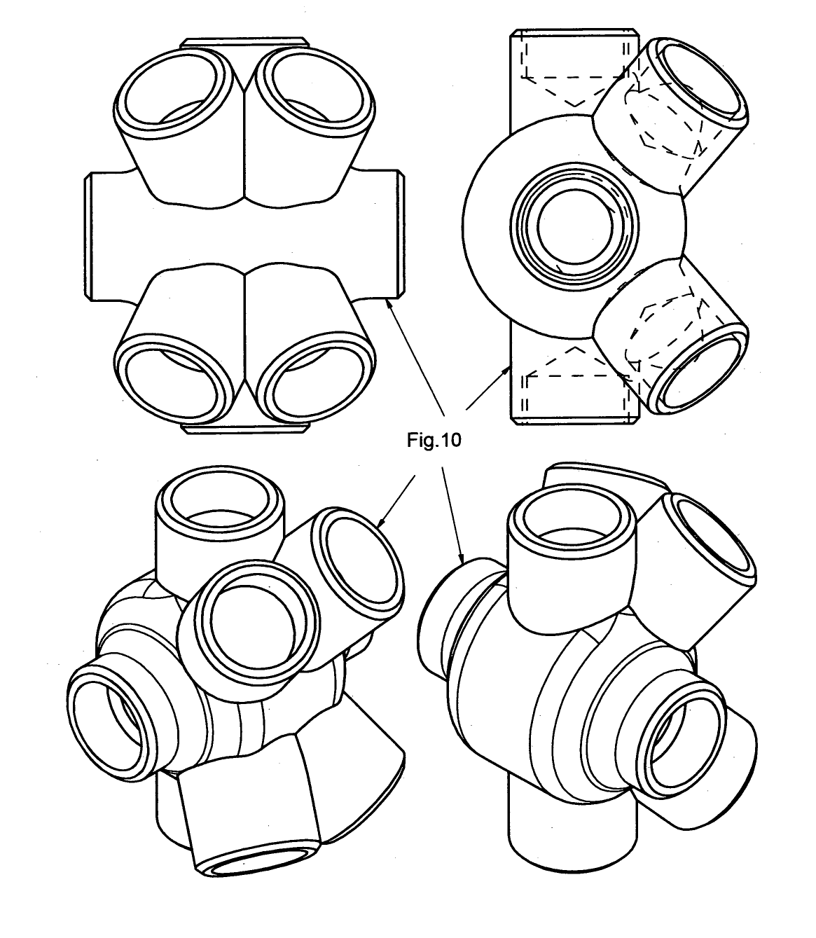

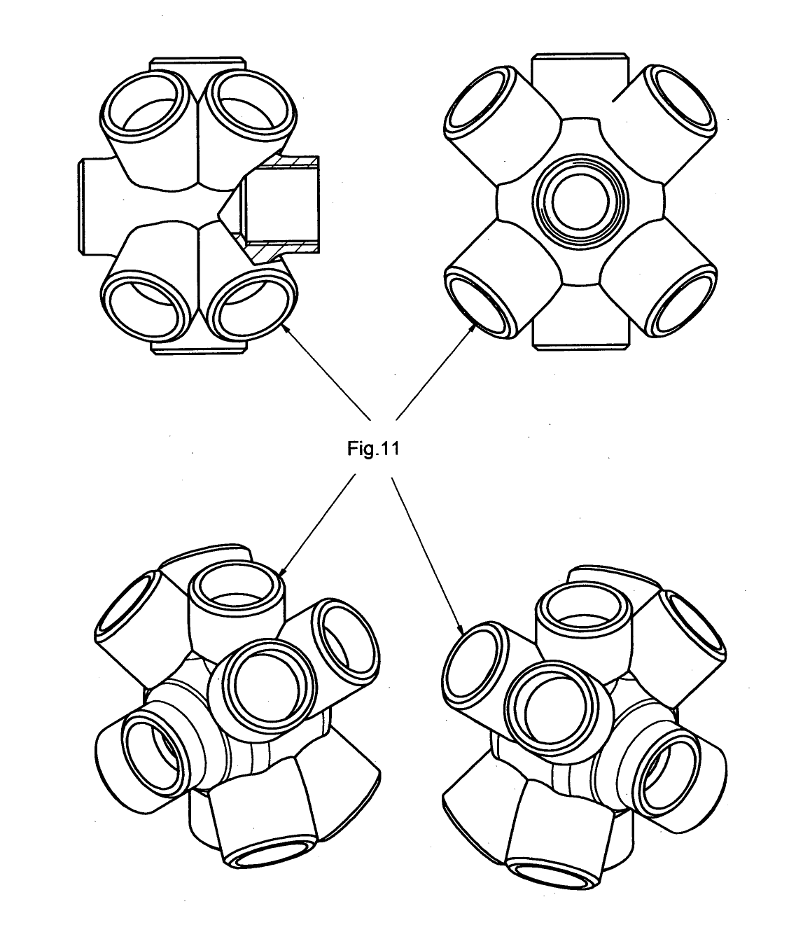

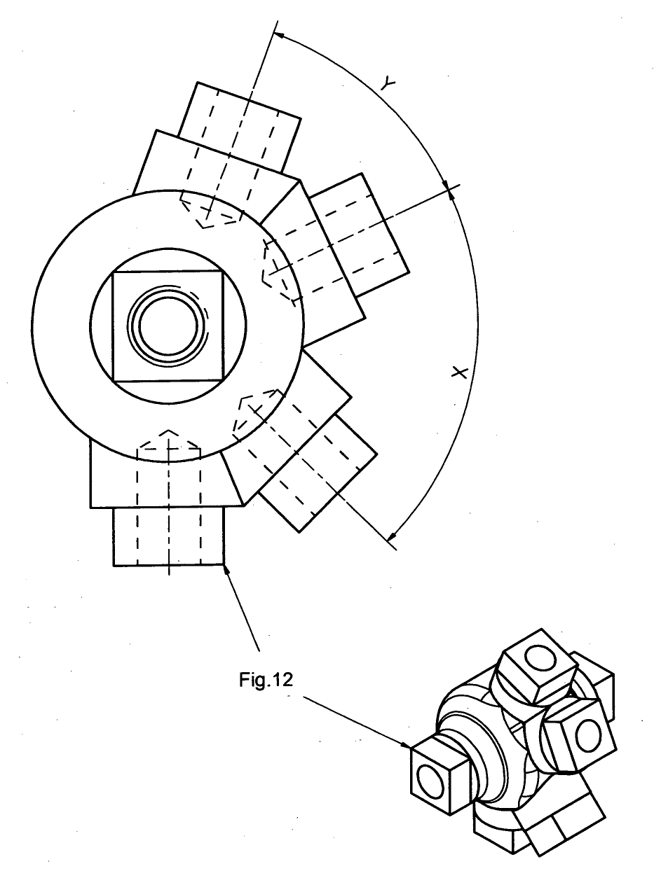

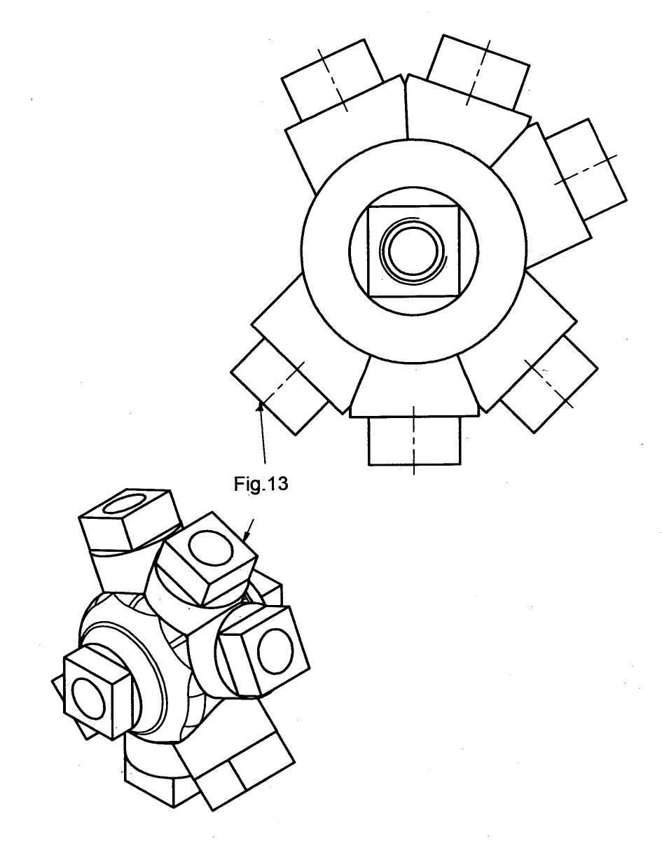

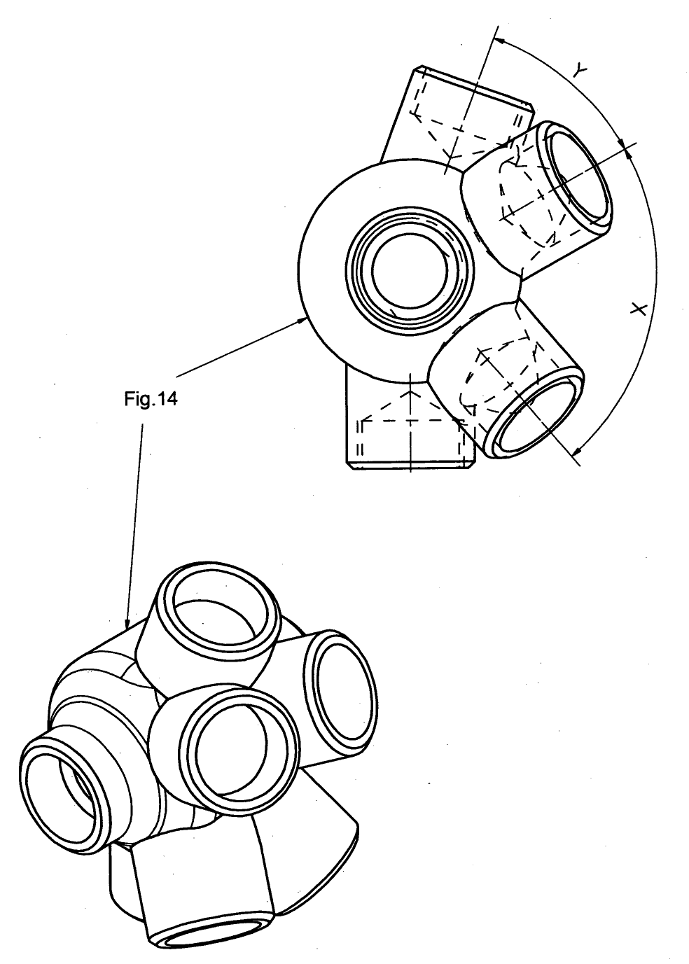

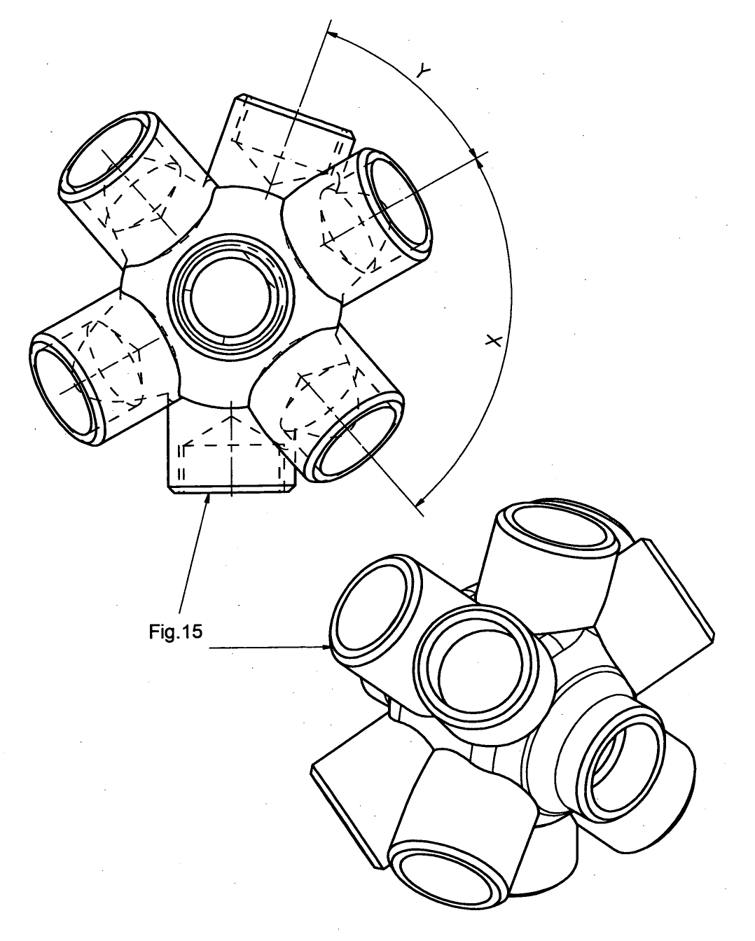

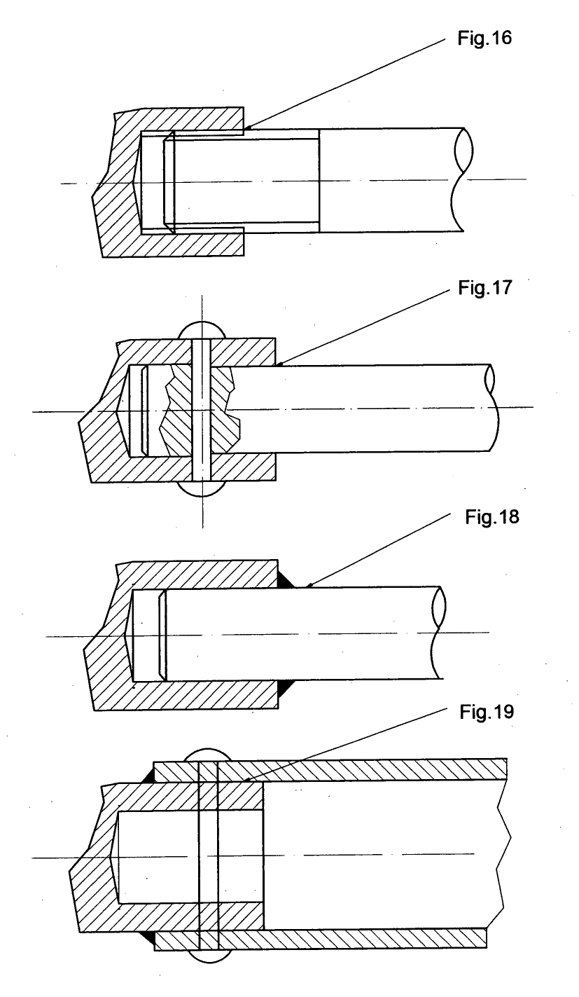

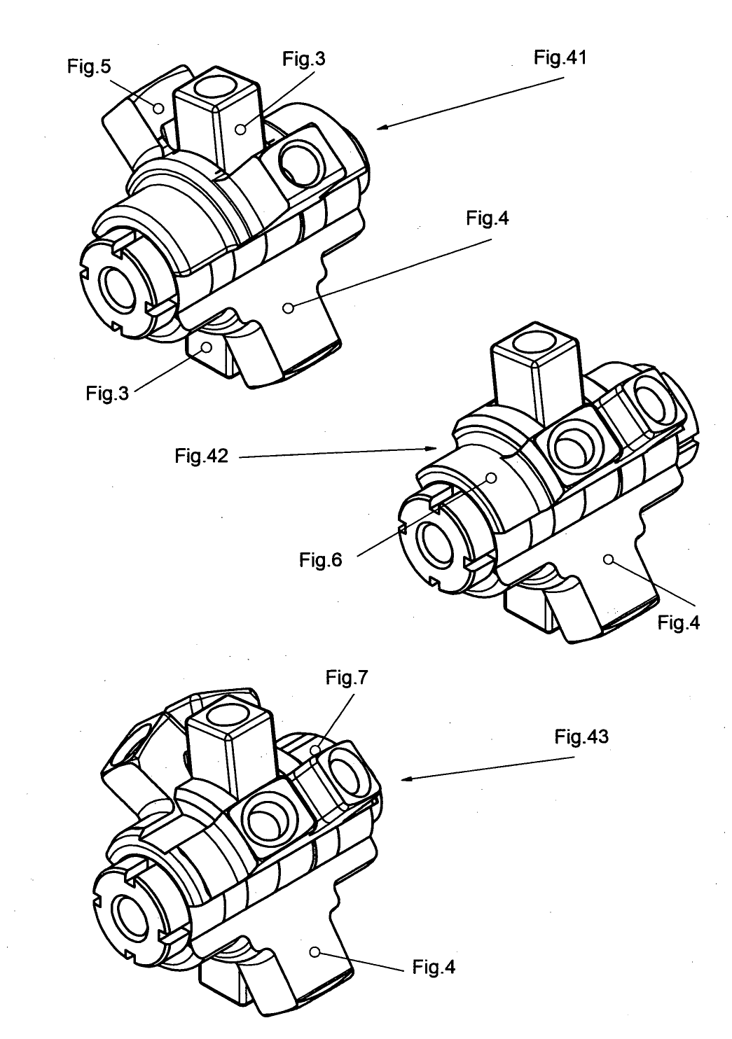

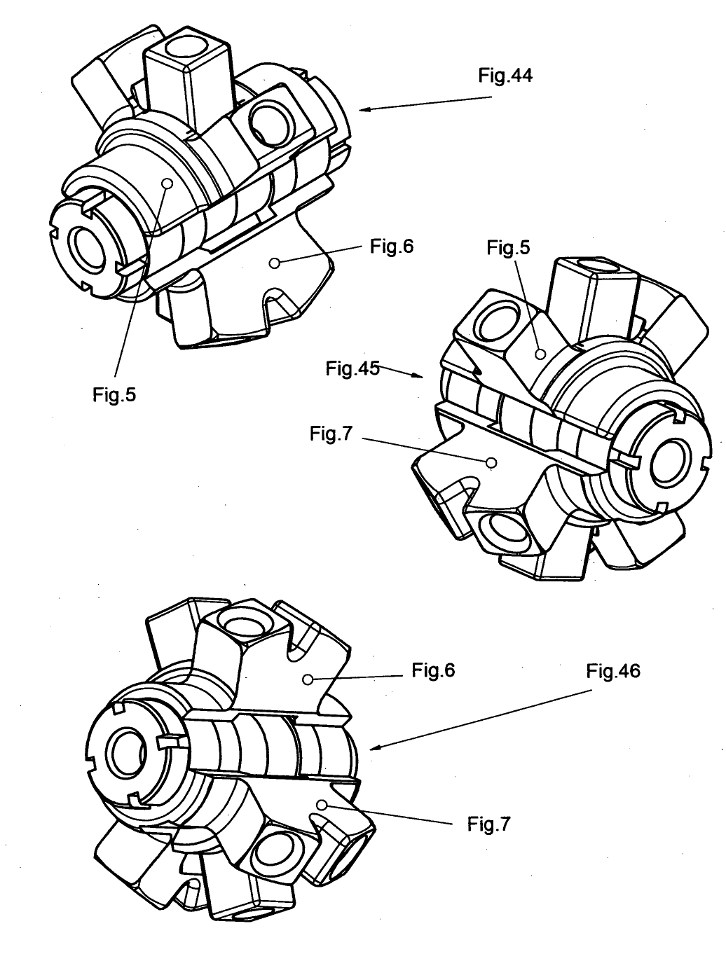

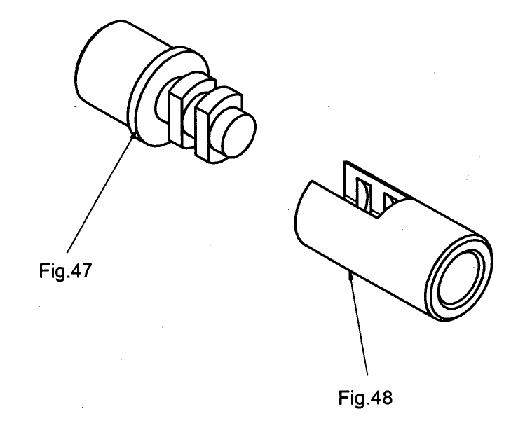

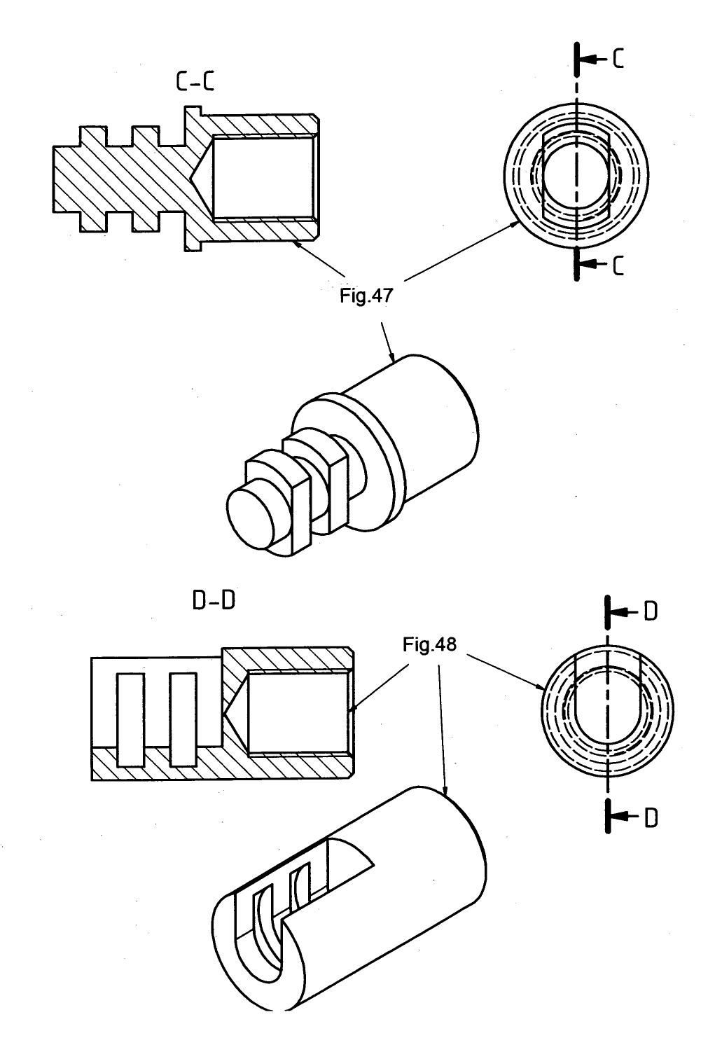

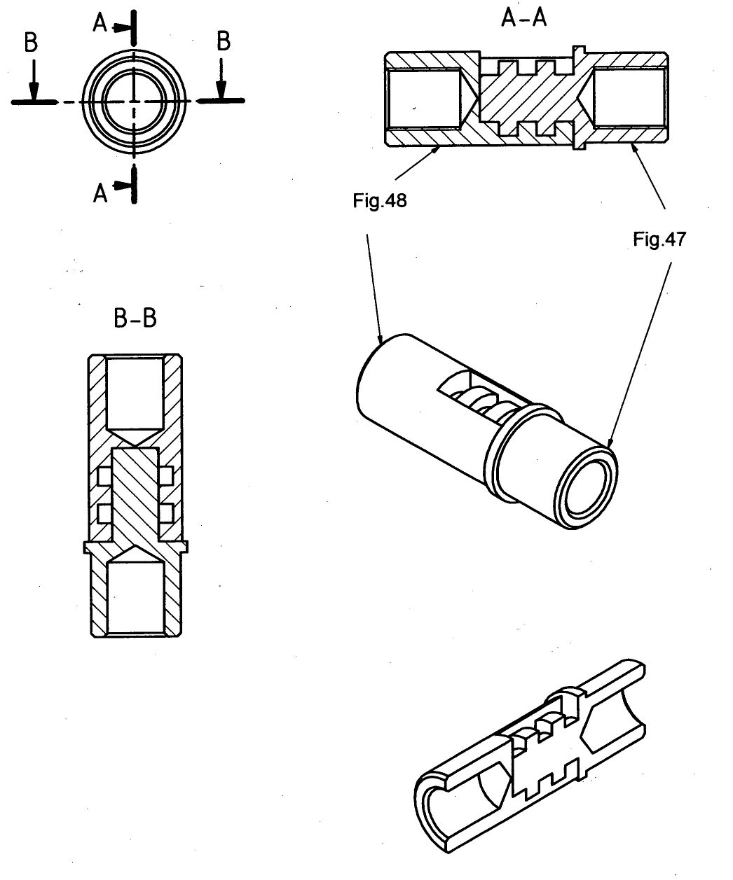

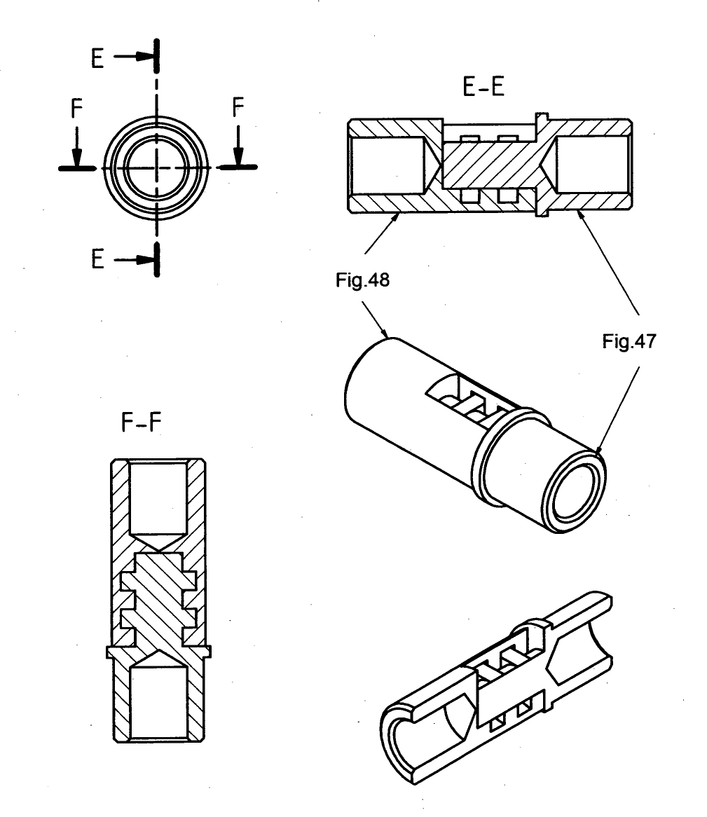

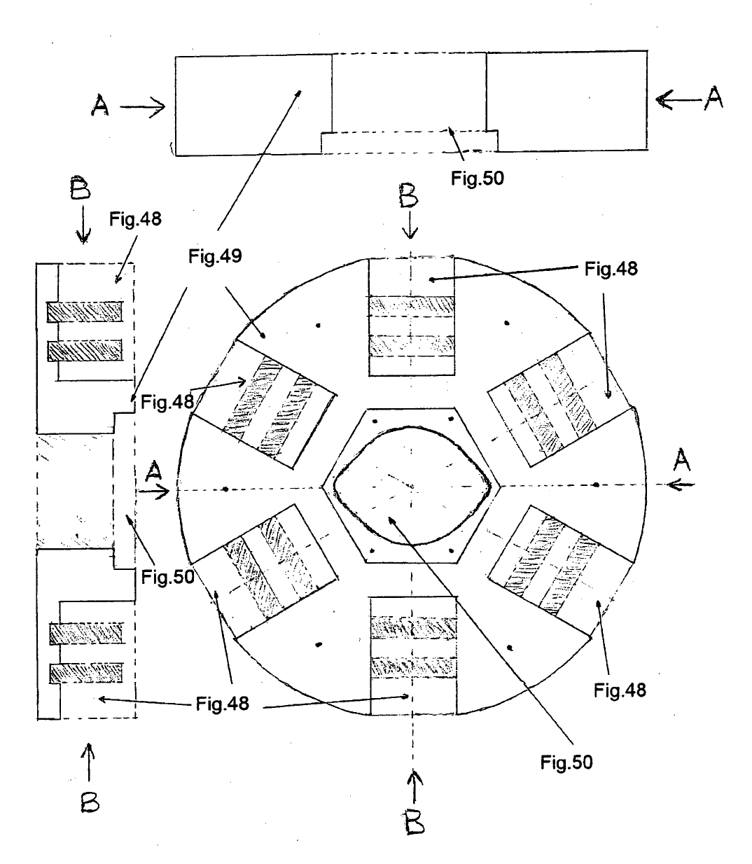

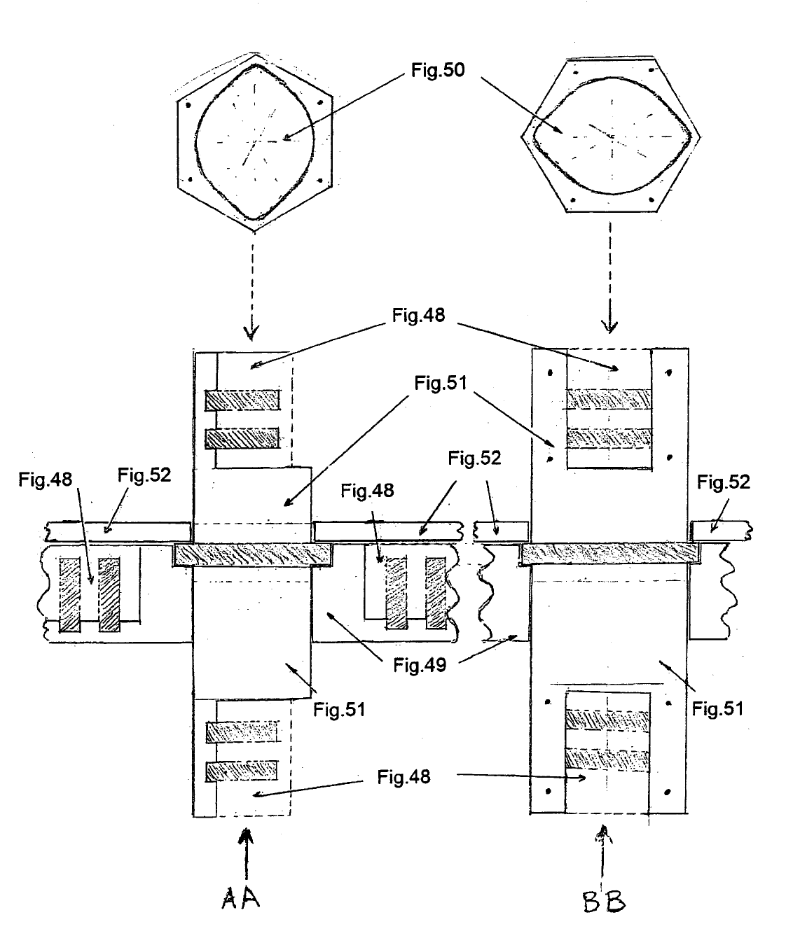

This invention refers to a variety of mechanical joints-nodes which are used to interconnect between them tubes, rods, beams of any cross section or size or material, in order to construct in an easy and fast way trusses of any shape size or strength, for use mainly in the building and construction industry, in architectural designs and in decorative structures, but also in many other cases like modular assemblies of educational games, modular bridges and roofing constructions and dwellings for immediate covering of special needs in disaster areas, greenhouses, scaffolding, sheds, towers, etc.

Truss constructions with any kind of materials and any size of tubes or rods or beams of any cross section, have always been used in all kinds of applications. In all cases the primary question has always been HOW to interconnect the tubes or rods or beams, i.e. the straight parts of the truss construction, between them. The usual up to now practice has been to study each truss construction case by case and find a solution according to the material used, the cross section of each straight part and the size and strength requirements of the truss.

In WOODEN trusses the usual practice is to specially carve the ends of each straight part either by technicians on site or by some industrial process and to complete the construction by fixing the sections with nails and/or screws and/or gluing, either between themselves or by specially designed joints-nodes.

In METALLIC trusses the ends of each straight section are specially treated and shaped in a similar philosophy, e.g. they are flattened by compression and holes are drilled in the flat areas or flanges are welded for fixing with screws or welded directly or fixed with some kind of notch/holder or some special kind of node specifically designed for each case. In some applications for decorative purposes, this node has the form of a ball with holes at the necessary positions for the required angles of the straight parts, which are interconnected by screwing or welding or securing somehow in the holes of the ball joints-nodes.

Under the above level of technical knowledge and expertise in general, there is no possibility for mass production of standardised joints-nodes or straight sections for a wide range of applications, with primary target the lowering of cost for production of the straight sections and the parts of the nodes and the cost and time for the truss construction. With the present level of expertise it is necessary to use specific methods in each case for shaping the ends of the straight parts and for designing the respective nodes for the different lengths, cross sections and kinds of straight parts and nodes. Some kind of standardization—mainly for decorative trusses—does exist in the case of interconnection with balls with holes or with flattening and drilling the ends of straight sections, but also in these cases there is no significant lowering of cost and time.

In the case of trusses of large size and heavy construction for use as strength 45 elements e.g. in buildings, for bridges, for roofing and coverings in general, etc, it is necessary to construct in the factory the complete truss or large sections of it with high cost special design and manufacturing methods for each case and there is need for time consuming and high cost procedures to transport the truss and/or its sections on site for erection/assembly with heavy lifting machinery.

Object of the present invention is the design of a series-variety of standardized components for the assembly of joints-nodes with variable-self adjusting angles for construction of trusses of any shape size or strength, as well as the design of a series-variety of standardized joints-nodes with fixed angles for construction of trusses of fixed shape and any size or strength according to the fixed nodes used. These standardized nodes of variable angles assembled from standardized components or of fixed angles, can be produced with standardized series production industrial methods in any size and from any material, according to the requirements of any specific application and in large quantities for significant reduction of cost of products.

The interconnection of the straight parts with the variable or fixed nodes can be achieved in various ways according to the application, the material of the nodes and of the straight parts and the strength requirements of the truss.

Tube straight parts can have opposite threadings at the two ends with respective threading at the holes of the nodes and they can be screwed-in at both ends by turning in one direction and screwed-out by turning in the opposite direction. Object of the present invention is also the devising of a standardized method of arranging/distributing the left and right threadings at the arms or receptacles of the various types of nodes, in a way that the tube straight parts that have opposite threadings at their two ends as mentioned above, can have always find respective opposite threadings at the at the receptacles of the nodes, in order to enable the simultaneous screwing-in at both ends by turning in one direction and unscrewing by turning in the other direction. This method has already been recorded with the Patent Application number 20060100699/22 Dec. 2006.

Another way for interconnection of straight parts of any cross section with the nodes, is to fit the straight part tight in the respective position of the node and to secure it with a through bolt-plug and/or welding.

Finally, one more way is to make the interconnection at each end with a two part mechanical connector consisting of a male and a female part, which can be interconnected with lateral movement and interlock with a small turn, and can be fixed at the ends of tubes rods beams of any shape to provide the capability of interconnecting these ends with simple lateral movement and turning. This two part mechanical connector has already been recorded with the Patent Application number 20060100673/13Dec. 2006. One more object of the present invention is the embedding of either one of the two parts of this mechanical connector into the arms/receptacles of the nodes.

The advantages of this invention are the following:

1. Significant reductions of production costs for the nodes and the straight parts and for the final truss construction, due to standardization of the components and the methods of construction-assembly of the trusses, by production of a variety of standardized nodes for any kind of application, with standardized series production industrial methods.

2. Minimizing of truss construction time by simplifying and standardizing the construction procedures, as well as easy and fast assembly-disassembly.

3. Infinite possibilities for fast designing of truss constructions of any shape size and strength.

4. Possibilities of assembly of truss constructions at the sites of installations with non specialized workforce and minimal needs for lifting equipment.

5. Possibilities for use of standard tubes, rods, beams from the general trade for production of straight parts for the trusses at the site of erection, with parallel use of simple portable equipment for cutting of the straight parts at the required lengths, followed by drilling or threading the ends of the straight parts and/or welding, according to the chosen interconnection method.

6. Absolute security for homogeneity and equal mechanical strength at ALL the interconnected ends of the streight parts with the node arms and absolute independence from human errors, both during the production of the straight parts and the nodes and during the construction of the truss on site.

The invention will be described below with reference to the attached drawings, where the various series of the different components nodes and indicative truss constructions, as well as the method of opposite threadings and the two part mechanical connector are illustrated in detail. All the different drawings of components and nodes are individually numbered and for easier recognition of all parts and models each part is given a characteristic name according to its use and operational characteristics.

Drawing 1/46 illustrates all the components of the variable node for construction of two dimensional single side trusses. The two identical small moving arms (3) are inserted in the holes of the two identical big moving arms (4) and all together are assembled on an axle (1) which is secured at the ends with nuts (2). The cross-section of the ends of arms and plug can have any shape, e.g. cylindrical.

Drawing 2/46 illustrates four views of the above node fully assembled. The angle X 35 which is formed between the two big moving arms (4), can vary and self-adjust with free turning of the two big arms on the axle (1). The angle Y which is formed between one big moving arm (4) and the associated small moving arm (3), can vary and self-adjust with free turning of the small arm (3) within the limits allowed by the hole on the associated big moving arm (4), which has the length of the sides in the direction of movement larger than the length of the width of the cross-section of the small moving arm.

The small moving arm (3) and the axle (1) with the nut (2) are the same common components for all the types of variable nodes described below, as long as they are of the same size, with the exception of the opposite threading in the holes for the opposite screwing interconnection method as further explained below.

Drawing 3/46 illustrates two views and two cut sections of the small (3) and big (4) moving arms.

Drawing 4/46 illustrates two views of a straight truss construction (20) with the variable node for construction of two dimensional single side trusses and tube straight parts (21). The two nodes in enlargement of the details J and K, illustrate the method of interconnection of the tube straight parts by screwing with opposite threading at the two ends of each straight part and respective threading in the receptacles of the arms. The ends of the straight parts that screw-in with right-clockwise turning (22R) have been marked with the letter R and the ends that screw-in with left-anticlockwise turning (23L) have been marked with the letter L. Respectively, the receptacles of the small and big arms that are used in each node have suitable threading to accept right-clockwise or left-anticlockwise turn screwing, depending on the position of the node and have been marked respectively with the letter R and L (3R) (3L) (4R) (4L). The angles X and Y are self adjusted and stabilized according to the lengths of the straight parts.

Drawing 5/46 illustrates a view of a three dimensional flat plane truss construction (24), which is formed from a number of straight trusses (20) illustrated in drw. 4/46, interconnected in parallel one next to the other with tube parts (25). This interconnection of identical parallel two dimensional trusses can again be achieved by opposite threading at the two ends of each straight tube part (25) and respective opposite threading at the two ends of the axle (1). This method of interconnection is illustrated in the enlarged detail K of the interconnected three dimensional truss.

The general principle for the interconnection method by screwing with opposite threading is that each of the straight parts have opposite threadings at its two ends and that there are two types of assembled nodes in one truss, the right-threaded one which has all the receptacles with right threading except two or three specific ones that have left threading and the left-threaded one, which is located opposite the right threaded in the truss construction, with opposite conditions, i.e. that has all the receptacles with left threading except two or three specific ones with right threading.

In each node of drawings 4/46, 5/46 there are two receptacles with opposite threadings from all the other ones in the node, the one is in the small moving arm (3) and the one in the one end of the axle. The cases with three reseptacles in each node with opposite threadings from all the others, are shown below.

Drawing 6/46 illustrates two views of a two dimensional bent truss construction (26) with the variable node for construction of two dimensional single side trusses and tube straight parts (21).

Drawing 7/46 illustrates view of a three dimensional bent plane truss construction (27), which is formed from a number of bent truss constructions (26) illustrated in drw. 6/46, interconnected in parallel one next to the other with tube parts (25). This interconnection can again be achieved by opposite threading at the ends of the tube parts (25) and respective opposite threading at the two ends of the plug (1), as for the flat plain truss illustrated in drw. 5/46.

Drawing 8/46 illustrates one view of a two dimensional truss construction (28) of special shape with the variable node for construction of two dimensional single side trusses and straight tube parts (21).

Drawing 9/46 illustrates one view of one more two dimensional truss construction (29) of special shape.

With the variable node it is possible to construct two or three dimensional trusses of any shape within the limitations imposed by the angles X and Y which are defined according to the lengths of the straight parts.

Any two dimensional truss of any special shape can be interconnected in parallel with identical trusses one next to the other with straight tube parts (25) using the method of opposite threading at the ends of the tube parts (25) and respective opposite threading at the two ends of the axle (1), for construction of respective three dimensional trusses of special shape.

Drawing 10/46 illustrates the components of the variable node for construction of two dimensional double side trusses. The two identical small moving arms (3) are inserted inside the holes existing on the two identical big moving arms (5) and all four arms are interconnected by the axle (1) which is secured at the ends with the nuts (2), with the same inventive principles as for the above variable node for construction of two dimensional single side trusses.

Drawing 11/46 illustrates four views of the above node for construction of two dimensional double side trusses fully assembled. The angles X and Y can vary as in the case of the variable node for construction of two dimensional single side trusses above.

Drawing 12/46 illustrates three views of the big moving arm (5) for construction of two dimensional double side trusses.

Drawing 13/46 illustrates two views of a straight truss construction (30) with the variable node for construction of two dimensional double side trusses and tube straight parts (21). The two nodes in enlargement in details A and B, illustrate the method of interconnection of the tube straight parts by screwing with opposite threading at the ends of each part and respective threading in the receptacles of the arms, with the same inventive principles as for the variable node for construction of two dimensional single side trusses of drw. 4/46 and 5/46 above.

Drawing 14/46 illustrates a view of three dimensional flat plane truss construction (31), which is formed from three straight truss constructions (30) illustrated in drw. 13/46, interconnected in parallel one next to the other with tube straight parts (25). This interconnection can again be achieved by opposite threading at the two ends of each straight tube part (25) and respective opposite threading at the two ends of the plug (1), as illustrated in the enlarged detail H.

Drawing 15/46 illustrates two views of a two dimensional bent truss construction (32) with the variable node for construction of two dimensional double side trusses and tube straight parts (21). The enlarged node in detail J illustrates the bent taken by the arms to form the said bent truss.

Drawing 16/46 illustrates the components of the variable node for construction of three dimensional single side trusses. The two identical small moving arms (3) are inserted inside the holes existing on the two identical big moving arms (6) and all four arms are interconnected by the axle (1) which is secured at the ends with the nuts (2), with the same inventive principles as for the variable nodes for construction of two dimensional single or double side trusses illustrated in drw. 1/46 and 10/46 above.

Drawing 17/46 illustrates four views of the above node for construction of three dimensional single side trusses fully assembled. The angles X and Y can vary as in the cases of the variable nodes for construction of two dimensional single or double side trusses illustrated in drw. 2/46 and 11/46 above.

Drawing 18 illustrates three views of the big moving arm (6) of the variable node for construction of three dimensional single side trusses.

Drawing 19/46 illustrates a view of a three dimensional straight truss construction (33) with the variable node for construction of three dimensional single side trusses and tube straight parts (21). The two nodes in enlargement in details H and G, illustrate the method of interconnection of the tube straight parts (21) by screwing with opposite threading at the two ends of each part and respective threading in the receptacles of the arms, with the same inventive principles as for the other variable nodes above.

Drawing 20/46 illustrates a view of three dimensional flat plane truss construction (34), which is formed from three truss constructions illustrated in drw. 19/46, interconnected in parallel with tube straight parts (25). This interconnection can be again achieved by opposite threading at the ends of each straight tube part (25) and respective opposite threading at the two ends of the axle (1).

Drawing 21/46 illustrates two views of a three dimensional bent truss construction (35) with the variable node for construction of three dimensional single side trusses and tube straight parts (21). The enlarged nodes in details F, E, illustrate the bent taken by the arms to form the said bent truss.

Drawing 22/46 illustrates one view (36) with two bent truss constructions (35) iillustrated in drw. 21/46, interconnected in parallel with tube straight parts (25). This interconnection can again be achieved by opposite threading at the ends of the tube parts and respective opposite threading at the two ends of the axle (1).

Drawing 23/46 illustrates one view (37) with two bent truss constructions of drw. 21/46 interconnected directly one next to the other.

Drawing 24/46 illustrates one view with four bent truss constructions (35) of drw. 21/46, interconnected directly one next to the other (38).

Drawing 25/46 illustrates the components of the variable node for construction of three dimensional double side trusses. The two identical small moving arms (3) are inserted inside the holes existing on the two identical big moving arms (7) and all four arms are interconnected by the axle (1) which is secured at the ends with the nuts (2), with the same inventive principles as for the other variable nodes illustrated in drw. 1/46, 10/46 and 16/46 above.

Drawing 26/46 illustrates three views of the above node for construction of three dimensional double side trusses fully assembled. The angles X and Y can vary as in the cases of the other variable nodes illustrated in drw. 2/46, 11/46 and 17/46 above.

Drawing 27/46 illustrates three views of the big moving arm (7) for construction of three dimensional double side trusses.

Drawing 28/46 illustrates a view of a three dimensional straight truss construction (39) with the variable node for construction of three dimensional double side trusses and tube straight parts (21). The two nodes in enlargement in details B and C, illustrate the method of interconnection by screwing the straight parts with opposite threading at the two ends of each part (22R) (23L) and at the arms of the nodes (3R) (3L) (4R) (4L).

In the case of nodes for construction of three dimensional trusses, there are three receptacles in each node that have opposite threadings from the other receptacles in the node.

Drawing 29/46 illustrates one view of a combined three dimensional straight truss construction (40) which is formed from the previous truss construction (39) directly interconnected with two identical trusses in one direction, with additional interconnection with parallel parts (25) through the axles (1), for even higher strength. Bent truss constructions are also possible with this variable node.

In the case of truss constructions of specified shape, either for permanent installation or for removable/re-assembled installation, the angles X and Y of the nodes are pre-selected and specific and it is not necessary to have the possibility of varying these angles on the nodes. In these cases the nodes can be fixed, provided that the required quantities of fixed nodes justify the cost of moulds for mass production with the specific angles X and Y, so that the final cost of the specific fixed node can be lower than the respective cost of a variable node of equal size and strength. The fixed nodes described below have been designed with the same inventive principles as for the variable nodes above, in order to achieve the same targets and advantages as with the variable nodes and constitute a variation of the variable nodes, in order to achieve even higher reduction of costs and simplification of the truss construction procedures.

One fixed node can be STRAIGHT when the sum of angles 2Y+X=180 degrees for construction of straight trusses or BENT when the sum of angles 2Y+X is larger or smaller than 180 degrees for construction of bent trusses of specific shape. The straight and bent fixed nodes and the variable nodes can be combined between themselves and used in the construction of one single truss of any shape.

Drawing 30/46 illustrates four views of straight fixed node (8) for construction of two dimensional single side straight shape trusses.

Drawing 31/46 illustrates four views of straight fixed node (9) for construction of two dimensional double side straight shape trusses.

In the above two drw. 30/46, 31/46, the ends of the arms are presented with square shape outside, in order to display the possibility-option of interconnection with hollow beams with respective cross section fitted outside, instead of tube straight parts fitted in the respective holes.

The above two fixed nodes can be substituted by one node with the shape of DISC with specific diameter and width, with the axle (1) incorporated in the center and vertical to the side of the disc. The arms may be substituted by receptacles in the perimeter of the disc at any angles required for each application. Alternatively, in the place of receptacles there can be arms of any diameter, if this is necessary for the interconnection method to be used. The number of arms or receptacles and their position in the perimeter of the disc can be chosen according to the needs of each application.

Drawing 32/46 illustrates four views of straight fixed node (10) for construction of three dimensional single side straight shape trusses.

Drawing 33/46 illustrates four views of straight fixed node (11) for construction of three dimensional double side straight shape trusses.

The above two fixed nodes can be substituted by one node with the shape of SPHERE with specific diameter, with receptacles at the required positions or arms extending out of the perimeter, respectively as for the DISC above.

Drawing 34/46 illustrates two views of bent fixed node (12) for construction of two dimensional single side bent shape trusses with specific x and y angles. In each specific model, the letters x and y are replaced by the actual degrees of the two angles.

Drawing 35/46 illustrates two views of bent fixed node (13) for construction of two dimensional double side bent shape trusses with specific x and y angles.

In the above two drw. 34/46, 35/46, the ends of the arms are presented with square shape outside, in order to display the possibility-option of interconnection with hollow beams with respective cross section fitted outside, instead of tube straight parts fitted in the respective holes.

Drawing 36/46 illustrates two views of the bent fixed node (14), for construction of three dimensional single side bent shape trusses with specific x and y angles.

Drawing 37/46 illustrates two views of the bent fixed node (15), for construction of three dimensional double side bent shape trusses with specific x and y angles.

The above two fixed nodes can be substituted by one node with the shape of SPHERE, as in the case of drw. 32/46, 33/46 above.

Drawing 38/46 illustrates three sections (16) (17) (18) which demonstrate the interconnection methods of straight parts of any cross section (21) (25) INSIDE the receptacles-holes in the arms of the nodes and one view-section (19) which demonstrates the respective interconnection methods of hollow beam straight parts (21) (25) of any cross section OUTSIDE the receptacles of the arms. The first view (16) illustrates the interconnection of tube straight parts by screwing-in, the second view (17) illustrates the interconnection of straight parts of any cross section with through pin-bolt and the third view (18) the interconnection of straight parts of any cross section with welding. In the first two cases (16) (17) it is possible to use welding additionally for even higher strength. The fourth view (19) illustrates the interconnection of hollow beams with through pin-bolt and/or welding. The straight part can have any cross section that fits tight inside or outside the respective receptacle of the arm and is interconnected with through pin-bolt and/or welding. The cross section of the receptacle of the arm does not have to be exactly the same as the respective cross section of the straight part, as long as one fits tight into the other. For example a straight part with a star shape cross section can fit tightly inside or outside a round receptacle and can be interconnected-secured with through pin-bolt and/or welding. The various shapes of cross section of the straight parts can have wide application in light truss constructions from aluminium or other suitable materials, e.g. plastics or glass, for decoration purposes.

In the case of through pin-bolt, the arms of the nodes can be produced directly with ready holes, so that in the field of construction there will only be need to drill holes in the tube or rectangular or any other profile straight parts will common portable drilling equipment.

The variable and fixed nodes of all types and sizes can be combined between themselves in one truss construction very easily, according to any special requirements of any building or architectural or decorative or artistic design.

Two big moving arms (4) or (5) or (6) or (7) of DIFFERENT types of nodes but of the SAME SIZE, can be assembled together with two SAME size small moving arms (3) on one SAME size axle (1), thus forming COMBINED variable nodes for use in very special applications-constructions.

Drawing 39/46 illustrates three combined variable nodes with the following combinations of big moving arms:

big arm (4) with big arm (5), (41)

big arm (4) with big arm (6), (42)

big arm (4) with big arm (7), (43)

Drawing 40/46 illustrates three combined variable nodes with the following combinations of big moving arms:

big arm (5) with big arm (6), (44)

big arm (5) with big arm (7), (45)

big arm (6) with big arm (7), (46)

Drawing 41/46 illustrates the parts of the two part mechanical connector for lateral interconnection of tubes, rods, beams of any cross section or size, the male (47) and the female (48).

The male part has at one end cylindrical shape with respective coaxial cylindrical hole of smaller diameter and can have screw threadings on the inside or outside surface of the cylinder. The remaining length of the part has also cylindrical shape of smaller diameter than the outside of the end cylinder above and can have respective coaxial through hole to the other hole of smaller diameter and also has one or two or more wings at the vertical to the axis, which have circular shape at the two ends and flat at the two sides. More specific, the perimeter surface of each wing is a circle which has two parallel arches cut-out from its opposite sides. The width between the two flat sides is equal to the diameter of the small cylinder.

The female part has cylindrical shape with coaxial cylindrical hole of smaller diameter as the male part and for some length along its body, there is a gutter with parallel flat sides and equal width as the flat sides of the wings of the male part. The gutter has a circular surface at the bottom with the same diameter as that of the small cylinder with the wings of the male part and vertical to the axis of the cylinder it has grooves with circular shape at the respective positions and with the same dimentions as the wings of the male part, so that the wings can fit exactly inside the grooves.

The shape/cross section of the wings in the male part, instead of parallelogram can have any other form like conical-wedge with circular shape at the top of the wedge and the respective grooves in the female part can have the similar shape for better fitting and easier connection and interlocking of the two parts.

Drawing 42/46 illustrates two cross sections of the two parts. (47) (48).

Drawing 43/46 illustrates the two parts interconnected at the first stage of their Jointing, before turning for interlocking and two cross sections of both in place. At the first stage of interconnection the male part is inserted laterally in the female part until reaching the end of the gutter.

Drawing 44/46 illustrates the two parts interlocked in the final stage-position and two cross sections. In the second and final stage of interconnection, the male part (47) or the female part (48), from the position it is after the first stage, is turned inside the other part by up to 90 degrees in one or the other direction, with the end result of the two parts to interlock at the 90 deg position with some locking method like plug or spring or tight fit or any other easy method. Additionally, the free space left on the side of the interlocked connector, may be filled with a plug or setting material for better protection against accidental turning and opening of the parts.

The outside shape of the male or female part, instead of cylindrical can have any other form like conical, paralleliped, polygon e.t.c., in order to fit with the shapes of tubes, rods, beams that will interconnect in the truss, to cover any decorative or other requirements.

The connection-fitting of the two parts at the ends of the straight parts, may be effected in various ways depending on the special needs of each application. For tubes of any material, the connection can be done by screwing-in the parts in the tube or or the tube in the parts, or alternative by welding or pressure fitting the parts on the tubes. With this methodology, one particular size of a two part mechanical connector can serve for two sizes of tubes, as long as the strength requirements are fully covered. For rods and beams, the connection may be done with welding or other method like pressure fitting, plug. The two part mechanical connector for lateral interconnection of tubes, rods, beams of any cross section or size, may be constructed from any material and at any size or special shapes-dimentions, depending on the special needs of each application.

In all cases of the nodes described above, the arms extending out of the node can have from original manufacturing the shape of the male (47) or female (48) part of the two part connector and the other respective part can be fitted to the ends of the straight part of the truss. With this system the assembly-disassembly of a truss is effected in a very fast and easy way.

In the case of the DISC node, the shape-form of the female part (48) of the two part mechanical connector, can be ebbedded-engraved axially in the body of the disc on one or the other or both sides, in as many positions and any angles needed for any particular application. After interconnection of the male part (47) in the female embedded in the disc, the sides of the disc can be covered-secured with respective size disc-cover, for final exclussion of accidental turning.

Drawing 45/46 illustrates an indicative fixed DISC node (49) that has the female part embedded axially every 60 degrees on one side. In the center of the disc there is an oval shape hole (50) to fit the axle (51), for parallel interconnection of the individual trusses with each other and at the same side with the female parts, there is a hexagonal or other shape groove for fitting and securing the axle (51).

Drawing 46/46 illustrates the above indicative fixed DISC node (49) with the axle (51) fitted in its place and in the hexagonal groove (50), in two cross sections that illustrate the small (AA) and the large (BB) diameter of the oval hole and the hexagonal groove. The axle has a respective ring in the middle that fits inside the groove (50) and secures in place with screws, while at its two ends has also embedded-engraved the female part (48) to enable the parallel interconnection of individual arches with each other with the same method. Additionally a disc-cover (52) of the same diameter with the DISC-node but less width and respective oval hole is fitted and secured with screws on the side of the DISC after interconnection of the male parts, to secure against accidental turning and unlocking.

In general the present invention provides to the Constructor, Civil Engineer, Architect, Decorator, even to the Sculptor-Artist and Children or Students (for playing or training), ENDLESS possibilities for designing truss constructions for every feasible application with the lowest possible general cost and the greatest easiness from any other available technical method.

1-9. (canceled)

10. A joint-node for interconnection of tubes rods or hollow beams-straight parts for construction of trusses of any shape size or strength that is constructed from any material and to any size and is characterised in that it is variable as it comprises five parts, two identical moving arms with single receptacle which are inserted and partly fitted in the suitable openings of two larger size moving arms with one or more receptacles and an axle upon which the arms are rotatably assembled and secured with nuts or the like and in that the angle X which is formed between the two larger size moving arms can vary and self-adjust with free turning of these two arms on the axle and the angle Y which is formed between one larger moving arm and the nearest single receptacle smaller moving arm can vary and self-adjust with free turning of this near smaller moving arm on the axle and within the limits allowed by the opening on the larger moving arm, which has its length in the direction of turning longer than the respective width of the cross-section of the inserted part of the smaller moving arm and in that the receptacles on the arms and axle for interconnection have any suitable shape to match the respective straight parts and the method of interconnection.

11. A joint-node as claimed in claim 10, characterised in that the two larger moving arms are identical and have one receptacle each for interconnection with straight parts and they move in the same plane with the receptacles of the two smaller moving arms vertically to the axis of the axle, so that it is possible to construct straight or bent or of any other shape two dimensional single width trusses that can be interconnected sideways with straight parts through the axle receptacles in order to construct flat or bent or of any other shape three dimensional trusses and in that, alternatively, the two larger moving arms are identical and have two receptacles each for interconnection with straight parts, which form a fixed angle between them and move in the same plane with the receptacles of the two smaller moving arms vertically to the axis of the axle, so that it is possible to construct straight or bent or of any other shape two dimensional double or multiple width trusses that can be interconnected sideways with straight parts through the axle receptacles in order to form flat or bent or of any other shape three dimensional trusses and in that, alternatively, the two larger moving arms are identical and have two receptacles each for interconnection with straight parts, which form a fixed angle between them and are in the same plane with the axis of the axle that moves vertically to the plane of the two smaller moving arms, so that it is possible to construct straight or bent or of any other shape three dimensional single width trusses that can be interconnected sideways with straight parts through the axle receptacles, or can be extended-interconnected sideways directly between them in order to construct flat or bent or of any other shape three dimensional single width trusses and in that, alternatively, the two larger moving arms are identical and have four receptacles each for interconnection with straight parts, which by two form a fixed angle between them in two planes that cross each other at the axle axis and form a fixed angle between them and the two adjacent such planes from each larger moving arm form the variable angle X, so that it is possible to construct straight or bent or of any other shape double or multiple width three dimensional trusses that can be interconnected sideways between them with straight parts through the axle receptacles, or can be extended-interconnected sideways directly between them in order to form flat or bent or of any other shape three dimensional trusses.

12. A joint-node as claimed in claim 10, characterised in that each joint-node has two different larger moving arms rotatably assembled on an axle with two identical smaller moving arms, so that they form six distinct combined variable joints-nodes from the six possible combinations of different larger arms, (4) with (5), (4) with (6), (4) with (7), (5) with (6), (5) with (7) and (6) with (7).

13. A joint-node as claimed in claim 11, characterised in that it is a single component with various fixed shapes, receptacles and X-Y angles that correspond to any respective shapes, receptacles and X-Y angles, of the arms and the axle of the variable node.

14. A two part mechanical connector for fast lateral interconnection of straight parts, tubes, rods, beams and the like, which is constructed from any material to any size and is characterised in that it comprises a male part which has cylindrical shape for part of its main body with one or more partly protruding wings vertical to its axis and at some distance between them, which have circular shape at their two opposite protruding ends with larger diameters from the main cylindrical body and flat shape at their two opposite parallel sides with the width between these two parallel sides equal to the diameter of the main body and in that the female part has a gutter for some length along its body comparable to the length of the the main cylindrical body of the male part, with parallel flat sides of almost equal but slightly larger width than the width between the flat sides of the wings and the diameter of the main body of the male part and with cylindrical surface at its bottom with almost equal but slightly larger diameter than the main body of the male part and vertically to its axis it has grooves with circular shape at the respective positions and with the same cross section dimensions as the protruding wings of the male part, so that the male part can exactly-tightly enter, flat sides to flat sides with lateral movement into the female part and the two parts interlock by turning one by up to 90 degrees to the other thus driving each wing of the male part to tightly fit inside the respective groove of the female part.

15. A method-system for linear interconnection of straight parts, tubes, rods, beams and the like, with any other parts by screwing, characterised in that each straight part has opposite threading receptacles at its two ends, one end left handed and the other right handed in either male of female form, whilst the parts to be screwed in or out at the two ends of the straight part, have been constructed to have the respective left or right hand threading receptacles in male or female form opposite facing each end of the straight part, so that the screwing-in both ends is achieved by turning the straight part in one direction and unscrewing by turning it in the opposite direction and in that this method-system is applicable for construction of russes with any possible kind of joint-node, which has been constructed to have the required left or right hand threading receptacles in male or female form, distributed in a suitable way on its body, to enable interconnection with the opposite facing respective left or right hand threading receptacles in male or female form at the ends of all the straight parts of the truss.

16. A two part mechanical connector as claimed in claim 14, characterised in that it is applicable for construction of trusses with any possible kind of joint-node, which is constructed to have the male or the female parts of the two part mechanical connector built-in or assembled and distributed in a suitable way on its body, to enable interconnection with the respective opposite female or male part, built in or assembled at the ends of all the straight parts of the truss.

17. A two part mechanical connector as claimed in claim 16, characterised in that it is applicable for construction of trusses with a joint-node which has the shape of a DISC with specific diameter and width and the male and female parts of the two part mechanical connector, are built-in or assembled on suitable locations and angles on the disc body, axle and perimeter, to enable interconnection with the respective opposite female or male parts, built in or assembled at the ends of all the straight parts of the truss.

18. A two part mechanical connector as claimed in claim 16, characterised in that it is applicable for construction of trusses with a joint-node which has the shape of a SPHERE with specific diameter and the male and female parts of the two part mechanical connector, are built-in or assembled on suitable locations and angles on the sphere body, to enable interconnection with the respective opposite female or male parts built in or assembled at the ends of all the straight parts of the truss.

19. A method-system for linear interconnection of straight parts as claimed in claim 15, characterised in that it is applicable for construction of trusses with a joint-node which has the shape of a DISC with specific diameter and width, which has been constructed to have the required left or right hand threading receptacles in male or female form, built-in or assembled on suitable locations and angles on its body, axle and perimeter, to enable interconnection with the opposite facing respective left or right hand threading receptacles in male or female form at the ends of all the straight parts of the truss.

20. A method-system for linear interconnection of straight parts as claimed in claim 15, characterised in that it is applicable for construction of trusses with a joint-node which has the shape of a SPHERE with specific diameter, which has been constructed to have the required left or right hand threading receptacles in male or female form, built-in or assembled on suitable locations and angles on its body, to enable interconnection with the opposite facing respective left or right hand threading receptacles in male or female form at the ends of all the straight parts of the truss.
